(19) United States
(12) Patent Application Publication
(10) Pub. No.: US 2021/0396245 A1
(43) Pub. Date: Dec. 23, 2021

(54) CENTRIFIGAL AND INERTIAL PUMP ASSEMBLY

(71) Applicant: James D. Castillo, Los Alamos, CA (US)

(72) Inventor: James D. Castillo, Los Alamos, CA (US)

(21) Appl. No.: 17/354,696

(22) Filed: Jun. 22, 2021

Related U.S. Application Data
(60) Provisional application No. 63/043,000, filed on Jun. 23, 2020.

(51) Int. Cl. F04D 29/42; F04D 29/62; F04D 29/22

(52) U.S. Cl. CPC F04D 29/4293; F04D 29/2288; F04D 29/628

(57) ABSTRACT

A pump assembly includes a shell having an inner surface defining an internal chamber, and a pumping frame moveable within the internal chamber. The shell and the pumping frame collectively defining a fluid circuit having a pair of arcuate segments. The pumping frame is configured to induce fluid movement along the fluid circuit in response to movement of the pumping frame relative to the shell. Fluid movement along the pair of arcuate segments generating a centrifugal force in a prescribed direction capable of independently moving the pump assembly.

### CROSS-REFERENCE TO RELATED APPLICATIONS

This application claims the benefit of U.S. Provisional Application No. 63/043,000 filed Jun. 23, 2020, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a pump assembly, and more specifically, to a pump assembly configured to move fluid within the pump assembly to generate a force which may contribute toward moving the pump assembly toward a particular direction.

### 2. Description of the Related Art

Propulsion generally relates to driving or pushing an object forward or in a desired direction. For instance, propulsion, in the form of thrust, is used to move an airplane through the air. A vehicle may be propelled by the forces generated from the vehicle's engine for moving the vehicle over a road.

Many propulsion modalities require interaction with the external environment. There may be an interest in reducing or eliminating the interaction between a particular propulsion modality and the external environment. Various aspects of the present disclosure address this particular need, as will be discussed in more detail below.

### BRIEF SUMMARY

Various aspects of the present disclosure relate to a pump assembly capable of moving fluid within the pump assembly to create desired mass imbalances for generating forces which may urge the pump assembly toward a prescribed direction. The forces may include centrifugal forces associated with the fluid traveling along an arcuate pathway, as well as Coriolis forces associated with the fluid traveling in a radial direction relative to an axis about which the arcuate pathway may extend. Fluid within the pump assembly may be successively added or removed from a given internal vessel within the pump assembly to further assist in creating desired mass imbalances within the pump assembly. The fluid may provide a desirable medium which facilitates such successive addition and removal.

In accordance with one embodiment of the present disclosure, there is provided a pump assembly includes a shell having an inner surface defining an internal chamber, and a pumping frame moveable within the internal chamber. The shell and the pumping frame collectively defining a fluid circuit having a pair of arcuate segments. The pumping frame is configured to induce fluid movement along the fluid circuit in response to movement of the pumping frame relative to the shell. Fluid movement along the pair of arcuate segments generating a centrifugal force in a prescribed direction capable of independently moving the pump assembly.

The pumping frame may be rotatable relative to the shell about a central axis. The pair of arcuate segments may both be disposed about the central axis.

The shell may include a main body and a pair of fluid transfer bodies coupled to the main body in generally opposed relation to each other. Each fluid transfer body may be configured to transfer fluid from one arcuate segment to the other arcuate segment.

The shell and the pumping frame may be configured to generate the centrifugal force in the prescribed direction independent of discharging any fluid from the shell.

The pumping frame may include a first carousel rotatable within the shell about a central axis in a first rotational direction and a second carousel rotatable within the shell about the central axis in a second rotational direction opposite the first rotational direction. The pump assembly may additionally include a plurality of vessels, with each vessel being rotatably coupled to a respective one of the first carousel and the second carousel.

Each vessel may include a proximal end portion adjacent the central axis and a distal end portion extending away from the central axis. Each vessel may be configured to rotate relative to the pumping frame about a respective vessel axis extending from the proximal end portion toward the distal end portion.

Each vessel may include an outer body and a plurality of veins extending within the outer body.

The first carousel may overlaps with the fluid circuit to define a first wet region of the first carousel. The pump assembly may additionally include a first impeller configured to urge fluid from a fluid source within the internal chamber toward the first wet region. The pump assembly may further include a diffuser extending around the first impeller and having a plurality of passageways extending radially therethrough between the first impeller and the first wet region.

According to another embodiment, there is provided a force generating device configured to generate a force as a result of fluid movement within the force generating device. The force generating device comprises an outer shell having an internal chamber, and

a pumping assembly moveable within the outer shell and at least partially defining a pair of force generating fluid movement segments and a pair of transfer flow segments. The pair of force generating fluid movement segments are configured to collectively generate a sufficient force to independently move the force generating device in response to fluid movement through the force generating fluid movement segments. The pair of transfer flow segments are configured to transfer fluid between the pair of force generating fluid movement segments and generate a pair of forces that counteract each other as fluid flows through the pair of transfer flow segments.

The outer shell and the pumping assembly may be configured to generate the sufficient force independent of discharging fluid from the force generating device.

The pair of force generating fluid movement segments may be of an arcuate configuration.

The force generating device may additionally include a middle plate located within the shell and dividing the interior chamber into a pair of sub-chambers. The pair of force generating fluid movement segments may be located in respective ones of the pair of sub-chambers.

Each of the pair of transfer flow segment may be configured to transmit fluid from a first one of the pair of sub-chambers to a second one of the pair of sub-chambers.

The pumping assembly may include a first sub-assembly and a second sub-assembly located in respective ones of the pair of sub-chambers. At least a portion of the first sub-assembly and at least a portion of the second sub-assembly may be rotatable about a central axis about which at least a portion of the shell is disposed. The at least a portion of the first sub-assembly which may be rotatable about the central axis may be rotatable in a first rotational direction, and the at least a portion of the second sub-assembly which may be rotatable about the central axis may be rotatable in a second rotational direction opposite the first rotational direction.

According to another embodiment, there is provided a pump assembly comprising an outer shell including a main body defining an internal chamber, and a pair of fluid transfer bodies in fluid communication with the internal chamber and extending from the main body in generally opposed relation to each other. Each fluid transfer body includes an inlet port configured to receive fluid and an outer port configured to discharge fluid. A first set of vessels is configured to move within the internal chamber and receive fluid from the outlet port of a first one of the pair of fluid transfer bodies and deliver fluid to the inlet port of a second one of the pair of fluid transfer bodies. A second set of vessels is configured to move within the internal chamber and receive fluid from the outlet port of the second one of the pair of fluid transfer bodies and deliver fluid to the inlet port of the first one of the pair of fluid transfer bodies. Fluid transfer by the first and second sets of vessels between the respective inlet and outlet ports generates a force sufficient to move the pump assembly.

The first and second sets of vessels may move in an arcuate path between the respective inlet and outlet ports.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1A is a side view of a pump in accordance with an embodiment of the present disclosure;

FIG. 1B is a front view of the pump assembly;

FIG. 1C is a bottom view of the pump assembly;

FIG. 1D is a top view of the pump assembly;

FIG. 2 is an enlarged, partial upper perspective view of the pump assembly;

FIG. 3 is an exploded upper perspective view of a priming pump and a motor for driving the priming pump;

FIG. 4 is an upper perspective view of the priming pump and motor mounted on a bottom plate;

FIG. 5 is an exploded upper perspective view of components forming a fluid supply circuit included in the pump assembly;

FIG. 6 is an assembled upper perspective view of the components depicted in FIG. 5;

FIG. 7 is an exploded upper perspective view of a lower diffuser assembly included in the pump assembly;

FIG. 8 is an upper perspective view of the lower diffuser assembly;

FIG. 9 is a top view of an impeller and a diffuser and veins included in the lower diffuser assembly;

FIG. 10 is a bottom view of the impeller and diffuser;

FIG. 11 is an upper perspective view of the impeller and diffuser and veins;

FIG. 12 is an exploded upper perspective view of an excess fluid return sub-assembly of the lower diffuser assembly shown with portions of the lower diffuser assembly;

FIG. 13 is an assembled upper perspective view of the excess fluid return sub-assembly;

FIG. 14 is a side view depicting internal components of the pump;

FIG. 15 is a lower perspective view illustrating opposite rotation of upper and lower drive assemblies;

FIG. 16 is an exploded upper perspective view of an upper gear rack, an idler plate, a plurality of idler gears, a lower gear rack, and a spoke;

FIG. 17 is a partial lower perspective view of a drive system used in the pump;

FIG. 18 is a partial exploded upper perspective view of a vessel carousel;

FIG. 19 is an upper perspective view of the vessel carousel;

FIG. 20A is an exploded upper perspective view of two rotating vessels configured to be received within the vessel carousel;

FIG. 20B is an upper perspective view of twelve vessels positioned within the vessel carousel;

FIG. 21 an upper perspective view of the veins included in a vessel;

FIG. 22 is an upper perspective view of a vessel including the veins depicted in FIG. 21;

FIG. 23 is an exploded upper perspective view of a single vessel circuit;

FIG. 24 is a partial exploded upper perspective view of a diffuser lid exploded to illustrate six vessels exposed to an open portion of the diffuser;

FIG. 25 is a top view of the vessel exposed to an open portion of the diffuser;

FIG. 26 is a top view of a set of vessels within a corresponding vessel carousel;

FIG. 27 is a side view of the set of vessels of FIG. 26;

FIG. 28 is a cross sectional view illustrating fluid flow through a vessel from a fluid transfer port;

FIG. 29 is a cross sectional view illustrating fluid flow through a vessel into the fluid transfer port;

FIG. 30 is a partial, side cross sectional view illustrating operative interaction between a vessel, a fluid transfer port, and an outer shell;

FIG. 31 is an enlarge view of the quadrangular region outlined in FIG. 30;

FIG. 32 is a lower perspective view of the pump with a section of the outer shell removed and one of the fluid transfer bodies removed to illustrate internal movement of the vessels and fluid flow through the fluid transfer body;

FIG. 33A is a front view illustrating transfer of fluid between the carousels via the fluid transfer bodies;

FIG. 33B is a side view illustrating transfer of fluid from an upper set of vessels toward a lower set of vessels;

FIG. 33C is a side view illustrating transfer of fluid from a lower set of vessels toward an upper set of vessels;

FIG. 34A is a side view of the pump assembly with the fluid transfer body and a portion of the shell removed to illustrate fluid transfer from lower vessels to upper vessels;

FIG. 34B is a reproduction of FIG. 34A, with the fluid flowing through the fluid transfer body having been removed to more clearly illustrate the vessels;

FIGS. 35A and 35B are partial upper perspective views illustrating a fluid transfer port on an outer shell;

FIG. 36A is a side view of an outer portion of the shell having the fluid transfer body extending therefrom;

FIG. 36B is a side view of an inner portion of the shell having the fluid transfer body extending therefrom at a pair of fluid transfer ports;

FIG. 37 is a side view of the pump with a portion of the outer shell removed to illustrate an exemplary fluid level with supply circuit, diffuser reservoirs and vessels open to the diffuser being full;

FIG. 38 is a partial, upper perspective, exploded view of an alternative embodiment of a middle plate, and carousel impellers having an integrated ring gear configured to interface with idler gears;

FIG. 39 is a side view depicting the middle plate, carousel impellers and ring gears integrated into the pump;

FIG. 40 is an upper perspective view of the middle plate and idler gears of FIG. 38, with one idler gear exploded for clarity;

FIG. 41 is an upper perspective view of the carousel impeller, idler gears and middle plate of FIG. 38;

FIG. 42 is a upper perspective view of the carousel impeller of FIG. 38 exploded from a hub and set screws used for micro adjustment of the position between the hub and carousel impeller;

FIG. 43 is a lower perspective view of the carousel impeller, hub, and set screws of FIG. 42;

FIG. 44 is an lower perspective view of a carousel;

FIG. 45 is an upper perspective view of another embodiment of a vessel exploded from a carousel hub;

FIG. 46 is an upper perspective view of the vessel and carousel hub of FIG. 45 taken from a different angle;

FIG. 47 is an upper perspective view of a plurality of hex-drive gears of the vessel of FIG. 45 received within respective openings formed in the carousel hub;

FIG. 48 is a partial upper perspective view of the carousel hub and hex-drive gears extending around a hub and rack gear;

FIG. 49 is an exploded upper perspective view of an alternative embodiment of several pump assembly components, including an alternate rack gear;

FIG. 50 is an exploded lower perspective view of the alternative embodiment depicted in FIG. 49;

FIG. 51 is an exploded, upper perspective view of an alternative embodiment of a vessel, vessel frame body, and cross bar having a bearing boss for receiving a bearing; and

FIG. 52 is an exploded, lower perspective view of the embodiment depicted in FIG. 51;

FIG. 53 is a partial exploded upper perspective view of an alternative carousel drive gear and vessel cross bar with port timing opening; and

FIG. 54 is a partial assembly upper perspective view of the embodiment depicted in FIG. 53.

Common reference numerals are used throughout the drawings and the detailed description to indicate the same elements.

### DETAILED DESCRIPTION

The detailed description set forth below in connection with the appended drawings is intended as a description of certain embodiments of a pump and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure, and are not for purposes of limiting the same, there is depicted a pump assembly 10 capable of create a fluid movement within the pump assembly 10 to achieve a desired force as a result of a continuous imbalance that may be created by the fluid movement. The desired force may be of a sufficient magnitude and may be directable toward a prescribed direction to independently move the pump assembly 10. The Figures depict arrow 12, which is representative of a direction of force generated by operation of the pump assembly 10.

In particular, the pump assembly 10 may be configured to define a flow circuit or transfer circuit on only one side portion of the pump assembly 10 (e.g., a wet side), with the opposing side portion of the pump assembly 10 being dry (e.g., no appreciable fluid flow). The configuration of the flow circuit may include a pair of arcuate shapes that are adjacent each other, e.g., one arcuate fluid movement path in an upper hemisphere of the pump assembly 10, and another arcuate fluid movement path in the lower hemisphere of the pump assembly 10, with the fluid circulating between the two arcuate fluid movement paths. The arcuate shape of the fluid movement paths may generate desired effects from inertial and centrifugal forces associated with the fluid movement. As a result, the movement of fluid within the pump assembly 10 may generate a force in a prescribed direction (for example, in the direction of arrow 12) without discharging any fluid from the pump assembly 10.

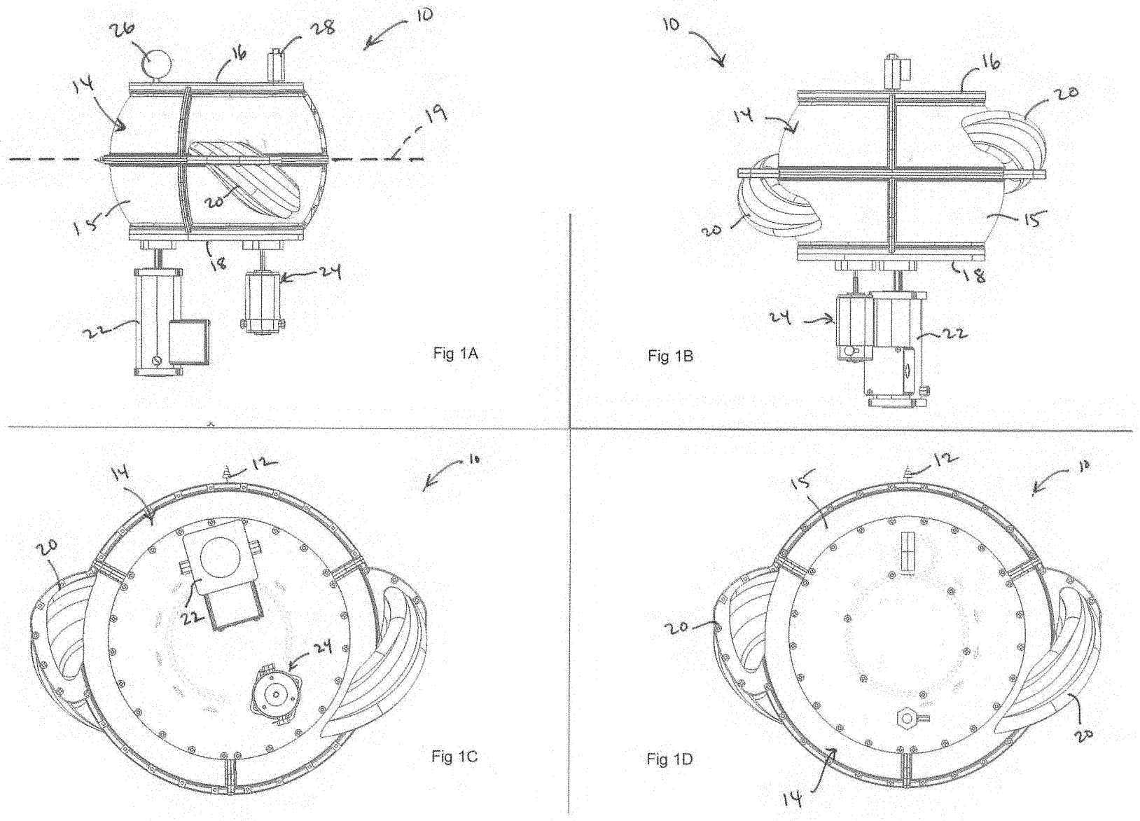

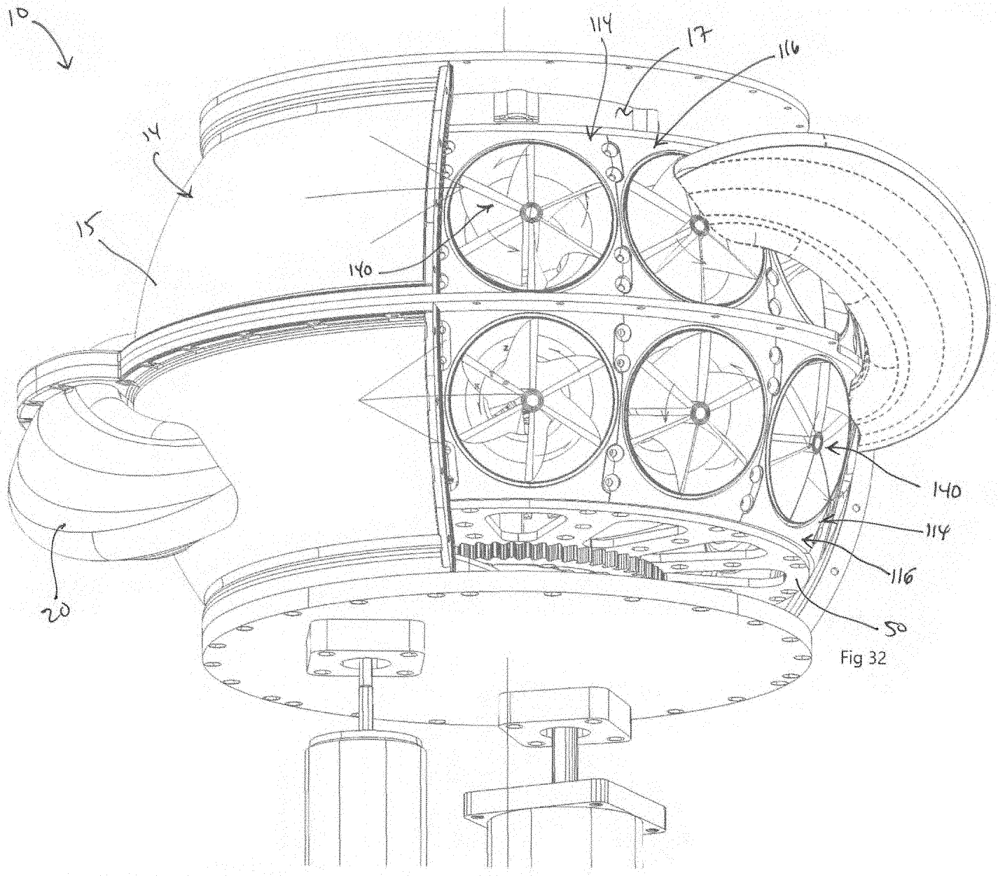

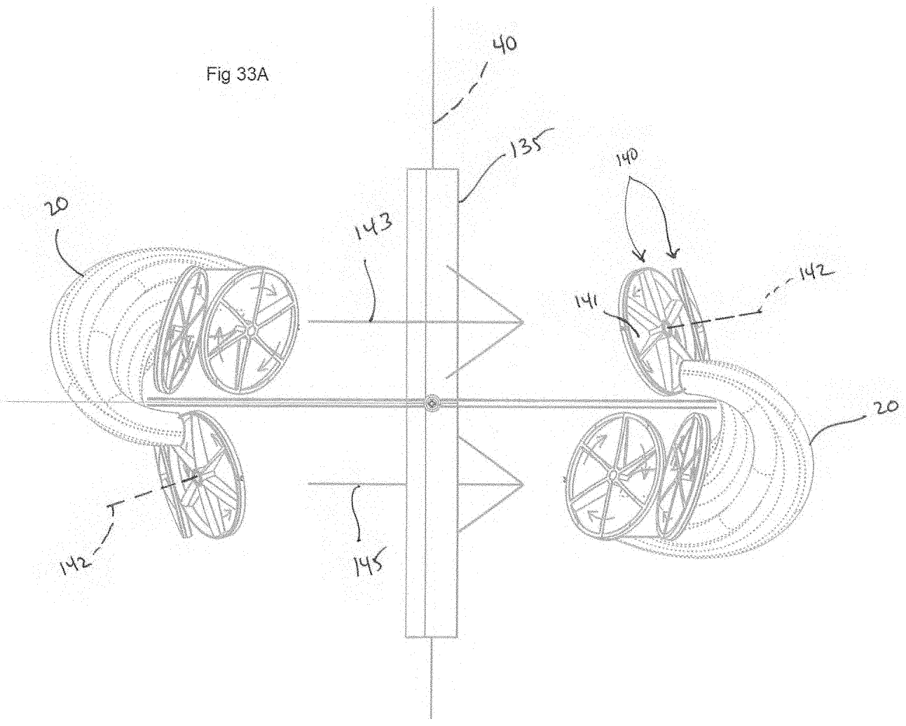

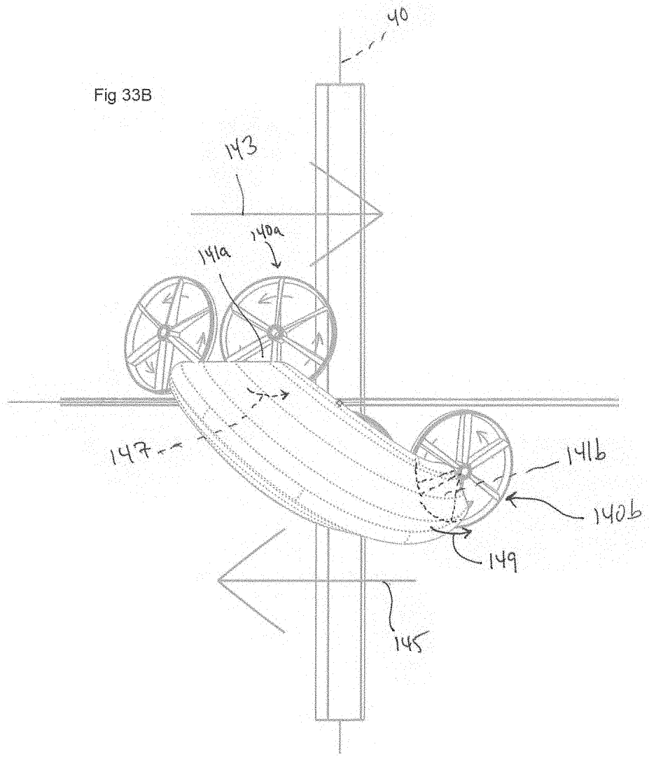

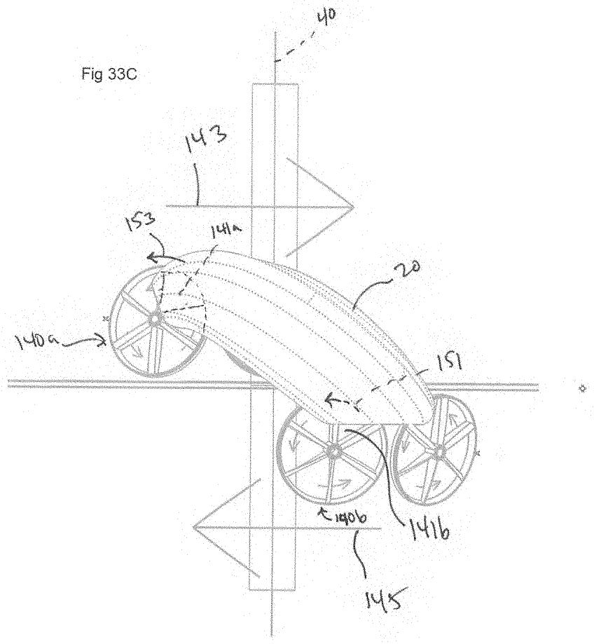

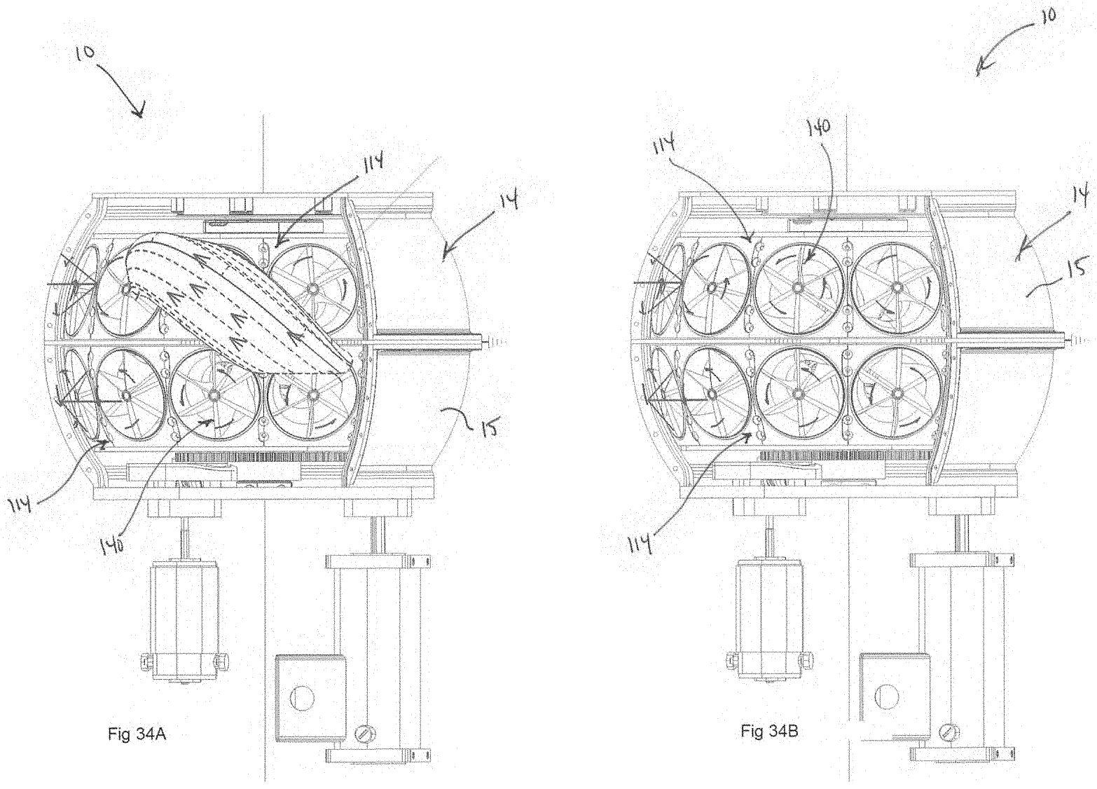

The pump assembly 10 in FIGS. 1A-D includes a shell 14 including a main body 15 and a pair of fluid transfer bodies 20 connected to the main body 15. The main body includes a generally spherical outer surface and an opposing inner surface, which at least partially defines an inner chamber 17 (see FIG. 32). The main body 15 may be divided into six segments, each of which may include flanges at their respective peripheries to facilitate attachment with adjacent shell segments. Although the exemplary embodiment shows the main body 15 as being segmented into six segments, it is also contemplated that the main body 15 may be formed by any number of segments or as a unitary structure.

The shell 14 may include a generally planar upper surface 16 and an opposing generally planar lower surface 18. The terms “upper” and “lower” (as well as “top” and “bottom”) as used herein refer to the orientation of the pump assembly 10, as depicted in FIGS. 1A-1D, although it is contemplated that the orientation may vary. In this regard, the terms “upper” and “lower” as used herein are not limiting. In this regard, it is contemplated that the pump assembly 10 may be used in several orientations that differ from that depicted in FIGS. 1A-1D; for instance, the pump assembly 10 may be used with the upper and lower surfaces 16, 18 may be rotated 90 degrees relative to the orientation shown in FIGS. 1A-1D. The shell 14 may also define a middle plane 19 or equatorial plane extending between the upper surface 16 and the lower surface 18.

Extending from opposed sides of the main body 15 are the pair of fluid transfer bodies 20. The inside of each fluid transfer body 20 may be hollow and define a portion of the interior chamber 17 of the shell 14. Each fluid transfer body 20 is arcuate and may define a generally helical configuration. Furthermore, each fluid transfer body 20 may include one end extending from the main body 15 on one side of the middle plane 19, and another end extending from the main body 15 on the other side of the middle plane 19. In this regard, the fluid transfer bodies 20 may transfer fluid from inside the main body 15 on side of the middle plane 20 to another portion inside the main body 15 on the other side of the middle plane 20. Each fluid transfer body 20 may include a fluid transfer inlet (e.g., inlet port) where fluid may be received into the fluid transfer body 20 and a fluid transfer outlet (e.g., outlet port) where fluid may be exhausted from the fluid transfer body 20.

The pump assembly 10 may further include a motor 22 and a centrifugal pump 24, both of which are shown in FIGS. 1A-1C as being attached to the bottom of the main body 15. The purpose of the motor 22 and the centrifugal pump 24 will be described in more detail below.

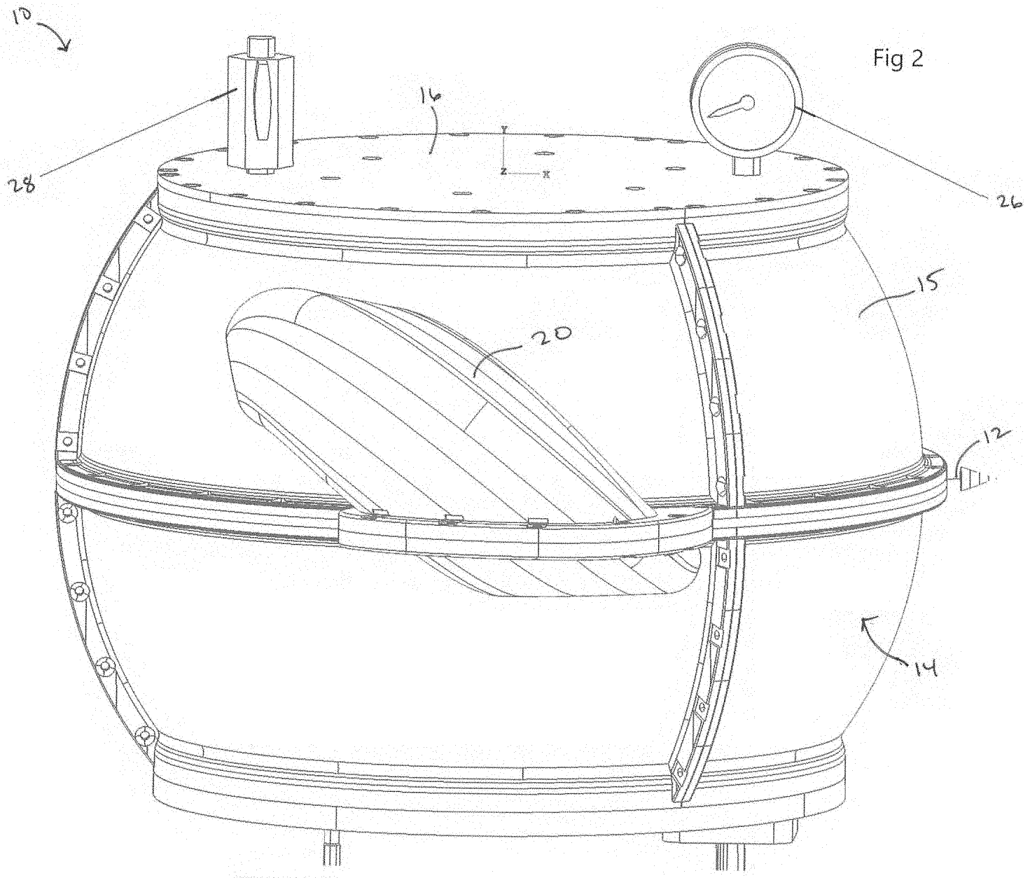

Referring now to FIG. 2, the pump assembly 10 may include a pressure gauge 26 and a valve 28 mounted on the upper surface 16. It is contemplated that the interior chamber 17 of the pump assembly 10 may be at a vacuum or negative pressure, and thus, the valve 28 may allow for connection to a vacuum source to apply a vacuum to the interior of the pump assembly 10. The pressure gauge 26 may be in fluid communication with the interior chamber 17 to measure fluid pressure within the interior chamber 17 and provide a reading on the gauge 26, which may be external to the shell 14. It is contemplated that the valve 28 may also be configured to facilitate filling (or re-filling) of the pump assembly 10 with the fluid that is ultimately circulated within the pump assembly 10.

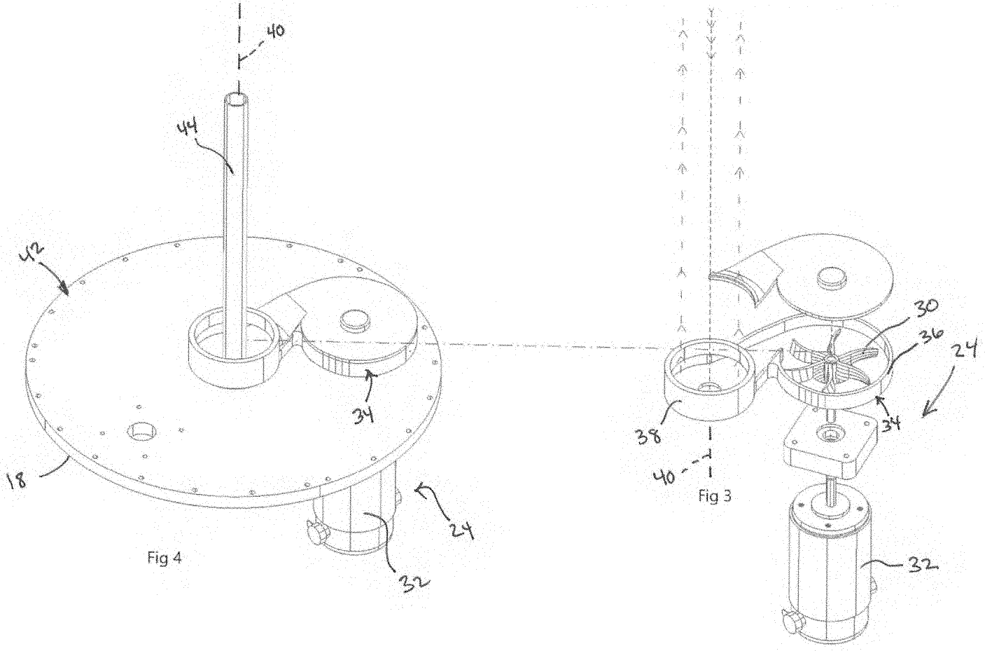

Referring now to FIGS. 3 and 4, the centrifugal pump 24 is shown, which includes a priming impeller 30 operatively coupled to a motor 32 which supplies a drive force causing rotation of the priming impeller 30. For instance, the priming impeller 30 may be attached to a shaft, which is coupled to the motor 32, such that the motor 32 causes rotation of the shaft, which in turn, causes rotation of the priming impeller 30. The priming impeller 30 is located within a housing 34 having a circular or arcuate sidewall 36 extending between a lower wall and an upper wall. The curvature of the sidewall 36 may allow for rotation of the priming impeller 30, and also allow the motion of the priming impeller 30 to drive fluid into a fluid supply passage, which corresponds to the upwardly pointing arrows depicted in FIG. 3. It is noted that the downwardly pointing arrows represent the return of fluid to a lower reservoir, which will be described in more detail below. The housing 34 is connected to a collar 38, which is disposed about a central axis 40, which may be aligned with the downwardly pointing arrows.

Although the exemplary embodiment shows a centrifugal pump 24, it is contemplated that any pump known in the art may be used without departing from the spirit and scope of the present disclosure. Furthermore, although the exemplary embodiment includes a separate motor 32 to drive the centrifugal pump 24, it is contemplated that other drive mechanisms may also be used to drive the pump 24.

Referring now to FIG. 4, the centrifugal pump 24 may be mounted to a bottom plate 42 of the pump assembly 10, which may define the lower surface 18. The impeller housing 34 and priming impeller 30 may be located on an internal side of the bottom plate 42 (e.g., opposite the lower surface 18), and the motor 32 may extend away from an external side of the bottom plate 42. The housing 34 may be mounted to the bottom plate 42 via screws, rivets or other mechanical fasteners known in the art. During use, the pump assembly 10 may be filled with fluid to a point wherein the impeller 30 is submerged within the fluid and resides within a lower reservoir. FIG. 4 additionally shows a return tube 44 which allows excess fluid to return to the lower reservoir, as will be explained in more detail below.

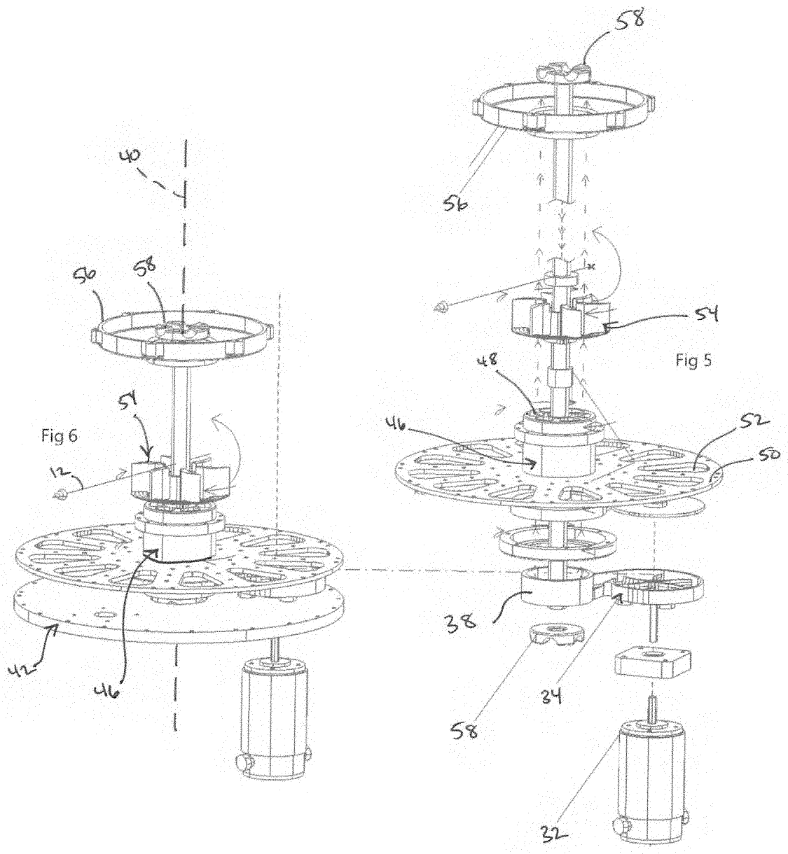

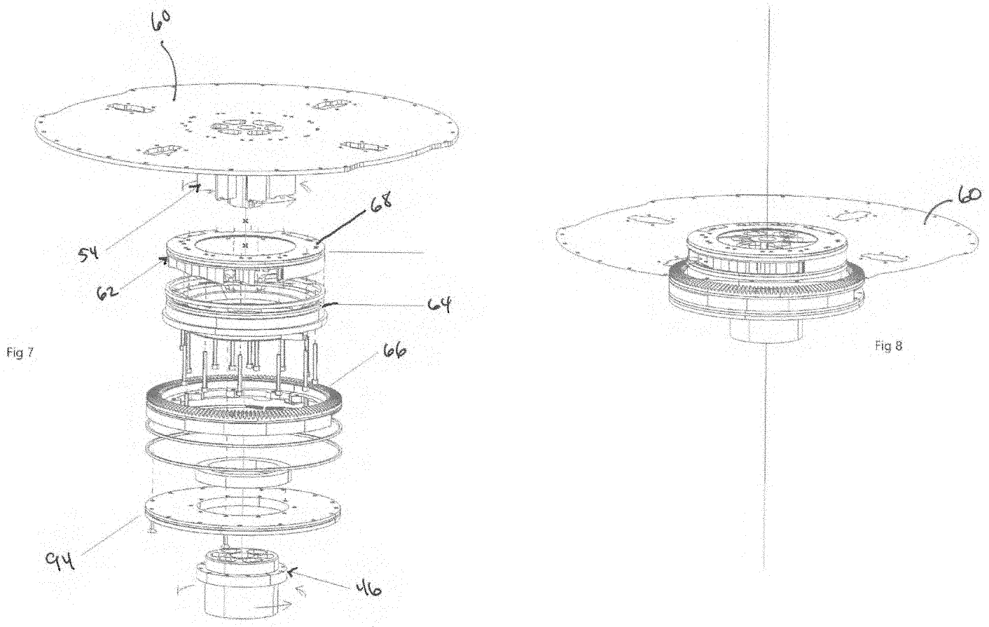

Referring now to FIGS. 5 and 6, there is depicted additional detail regarding a fluid supply circuit, which supplies fluid from a lower reservoir to a primary fluid movement circuit, which will be described in more detail below. FIG. 5 is an exploded view of the assembly depicted in FIG. 6, with the exception of the bottom plate 42, which is not shown in FIG. 5 for purposes of clarity.

The collar 38 is in fluid communication with a hub 46, which includes a plurality of openings or hub passageways 48 extending axially therethrough between opposed surfaces thereof. The hub passageways 48 receive fluid from the centrifugal pump 24 and deliver the fluid to additional components downstream of the hub 46 being proximate the centrifugal pump 24. The hub 46 may be in operative communication with the motor 22, such that the motor 22 is capable of generating a force which causes the hub 46 to rotate about central axis 40. The arrows depicted in FIG. 5 illustrate a direction of rotation of the hub 46.

The hub 46 is coupled to a lower carousel plate 50, such that the lower carousel plate 50 rotates with the hub 46. A seal mount may be aligned with the collar 38, which interfaces with a seal extending between the collar 38 and the lower carousel plate 50. The lower carousel plate 50 includes plurality of openings 52 formed therein and equidistantly spaced about the lower carousel plate 50. The openings 52 in the lower carousel plate 50 and may aid in the assembly of the pump assembly 10, and may also allow for drainage of fluid that may seep or leak from the fluid circuit into the main reservoir.

The hub 46 is connected to a carousel impeller 54 such that the carousel impeller 54 rotates with the hub 46. The carousel impeller 54 is configured to receive fluid supplied from the centrifugal pump 24, via the hub passageways 48, and urge the fluid in a radially outward direction toward the primary fluid movement circuit, which includes an arcuate segment positioned radially outward from the carousel impeller 54. The arcuate segment and the carousel impeller 54 may reside in a common plane that is perpendicular to the central axis 40. The carousel impeller 54 is positioned opposite the lower carousel plate 50, such that the hub 46 extends between the carousel impeller 54 and the lower carousel plate 50. In one embodiment, the hub 46 may include axial projections that are received in corresponding axial recesses formed on the carousel impeller 54 to facilitate the interconnection between the hub 46 and the carousel impeller 54. Alternatively, the recesses may be formed on the hub 46 and the projections may be formed on the carousel impeller 54. Other mechanical fastening techniques, such as the use of adhesives, fasteners, etc., may also be used to attach the hub 46 to the carousel impeller 54.

Centerline XX is depicted and all rotating components depicted in FIGS. 5 and 6, i.e., the lower carousel plate 50, the hub 46, and the carousel impeller 54, include counterpart components above the centerline XX, with those rotating components being copied 180 degrees on the opposite side of the centerline XX. In this regard, the pump assembly 10 includes a pair of carousel plates 50 (e.g., a lower carousel plate and an upper carousel plate), a pair of hubs 46 (e.g., a lower hub 46 and an upper hub 46), and a pair of carousel impellers 54 (e.g., a lower carousel impeller and an upper carousel impeller). The lower carousel plate 50, the lower hub 46 and the lower carousel impeller 54 all rotate in unison together as a first unit in the same rotational direction, while the upper carousel plate 50, upper hub 46, and upper carousel impeller 54 all rotate in unison together as a second unit in the same rotational direction, that is opposite to that of the first unit. In this regard, the lower hub 46 and upper hub 46 rotate in opposite rotational directions. Similarly, the lower carousel impeller 54 and the upper carousel impeller 54 rotate in opposite rotational directions, and the lower carousel plate 50 and upper carousel plate 50 rotate in opposite rotational directions.

The return tube 44 extends through the collar 38, the lower seal, the lower carousel plate 50, the lower carousel impeller 54, the upper carousel impeller 54, the upper carousel plate 50, the upper seal, and continues through an upper reservoir dish 56. As such, the return tube 44 may be configured to transfer excess fluid that collects in the upper reservoir dish 56 from the upper reservoir dish 56 to the lower reservoir. The return tube 44 is connected at both ends to respective end bodies 58, each of which may include four arcuate or concave channels configured to facilitate fluid flow into or out of the return tube 44.

Although the exemplary embodiment includes the return tube 44, it is contemplated that other embodiments may not include the return tube 44, and instead, may rely on passageways/openings formed in the various components to allow for fluid flow of excess fluid into the lower reservoir.

Referring now to FIGS. 7 and 8, a middle plate 60 is depicted along with the hub 46 and carousel impeller 54, as well as several non-rotating structures, which are mounted to the middle plate and extend around the hub 46 and the carousel impeller 54. In particular, there is depicted a diffuser base 62, a diffuser lid 64, and a rack gear 66, each of which may be generally annular structures coaxially aligned with the hub 46 and carousel impeller 54. The carousel impeller 54 and hub 46 may rotate relative to the diffuser base 62, the diffuser lid 64, and the rack gear 66 during operation of the pump assembly 10.

As can be seen in FIG. 7, each diffuser base 62 may include a generally planar surface 68 that is fixedly connected to the middle plate 60. Thus, while the carousel impeller 54 may rotate relative to the middle plate 60, the diffuser base 62 does not rotate relative to the middle plate 60.

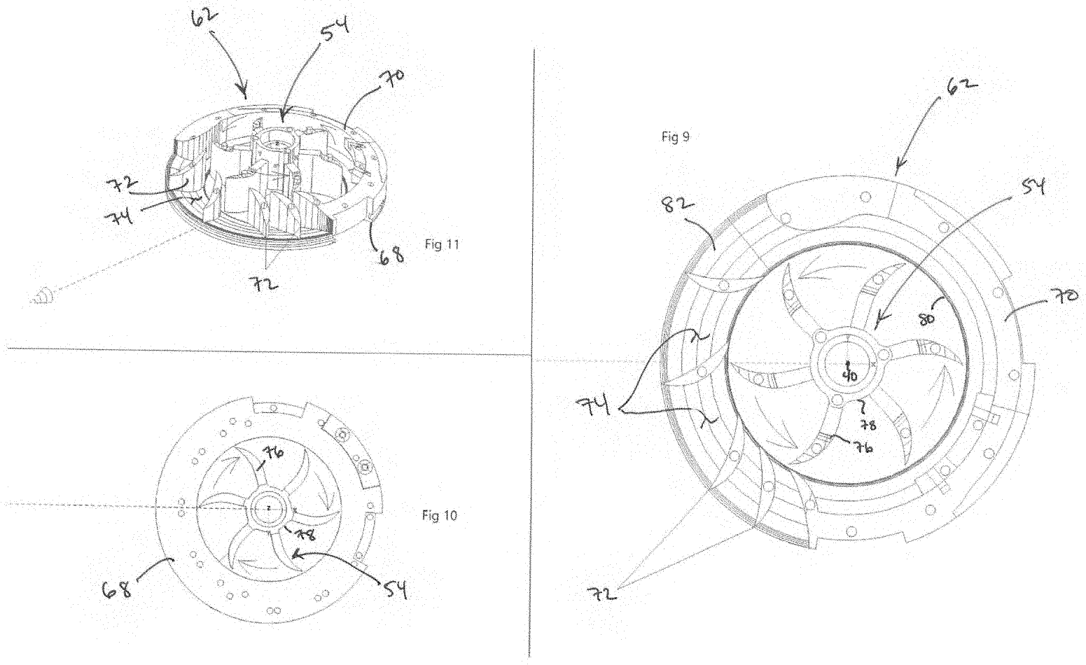

Referring now to FIGS. 9-11, the carousel impeller 54 and diffuser base 62 are shown in more detail. Arrows are included in FIGS. 9-11 to illustrate a direction of rotation of the carousel impeller 54, which rotates relative to the diffuser base 62. The diffuser base 62 may include a diffuser sidewall 70 extending from the generally planar surface 68 to define a closed section of the diffuser base 62. The diffuser base 62 may additionally include several diffuser veins 72, which may be spaced from each other and the ends of the sidewall 70 to define a plurality of radially extending diffuser passageways 74. The diffuser passageways 74 may define an open section of the diffuser base 62. It is contemplated that certain embodiments of the diffuser base 62 may be formed without diffuser veins 72.

The diffuser base 62 includes an inner surface 80 of the diffuser sidewall 70, which defines the closed section of the diffuser base 62, i.e., the sidewall 70 may be configured to prevent radial flow of fluid therethrough. The diffuser veins 72 may be fixed relative to each other and extend from a vein support surface 82 having an inner edge and an outer edge. The distance between the inner edge and the outer edge along a radial axis extending outwardly from the central axis 40 may refer to a support surface width. Each vein 72 may include a concave surface and a convex surface to define a pair of opposed tips, with the distance between the tips defining a vein length. The vein length may be greater than the support surface width; however, the veins 72 may be oriented relative to the vein support surface 82 such that no portion of the vein 72 protrudes beyond the inner edge or the outer edge. In this regard, the veins 72 may be oriented to relative to the vein support surface 82, such that the axis extending between the two tips is angularly offset from a radial axis extending from the central axis and passing through the vein tip adjacent the inner edge of the vein support surface 82 to define a vein offset angle. The magnitude of the vein offset angle may be unique to each vein 72, with the angle increasing from a first vein 72 toward a last vein 72, relative to the rotational direction of the carousel impeller 54.

The veins 72 may be separated from each other and from the diffuser sidewall 70 to create the radially extending diffuser passageways 74. The size and shape of the passageways 74 may vary, depending on the spatial arrangement of the veins 72 relative to each other and the sidewall 70. In the exemplary embodiment, a first passageway 74 extends between the sidewall 70 and a first vein 72, a second passageway 74 extends between the first vein 72 and a second vein 72, a third passageway 74 extends between the second vein 72 and a third vein 72, a fourth passageway 74 extends between the third vein 72 and a fourth vein 72, and a fifth passageway 74 extends between the fourth vein 72 and the sidewall 70. The end of the sidewall 70 adjacent the fourth vein 72 may include a vein-like structure, including a concave surface opposite the convex surface of the fourth vein 72. Furthermore, the sidewall 70 may include a convex surface opposite the concave surface of the first vein 72.

The exemplary carousel impeller 54 includes six veins 76 connected to a hollow central hub 78, which is sized to allow for passage of the return tube 44 therethrough. Each vein 76 includes a convex face and an opposing concave face, which converge at a distal end. The direction of motion of the carousel impeller 54 may be such that the convex face is the leading face, while the concave face is the trailing face. The convex and concave faces define a vein configuration which includes a proximal portion extending from the hollow central hub 46 and a trailing portion which curves away from the proximal portion and extends behind the proximal portion in a direction opposite the direction of rotation. Each vein 76 may define a radius as the distance between the distal end and the outer surface of the hub 46 along an axis extending between the distal end and the central axis 40. The radius of the veins 76 may be substantially equal and may be slightly less than an inner diameter of the diffuser base 62, as defined by an inner surface of the sidewall 70. Although the exemplary embodiment of the carousel impeller 52 includes six veins 76, it is contemplated that any number of veins 76 (e.g., 1 vein, 2 veins, . . . 7 veins, 8 veins, . . . etc.) may be incorporated into the carousel impeller 52.

As the carousel impeller 54 rotates, the impeller veins 76 create a rotational fluid flow within the diffuser base 62, with the fluid being urged to flow radially outward, as a result of the centrifugal force associated with the rotational fluid flow. The sidewall 70 blocks such radial flow, while the passageways 74 accommodate such radial flow. Fluid flowing through the passageways 74 may be received in vessels moving in proximity to the diffuser base 62, as will be described in more detail below.

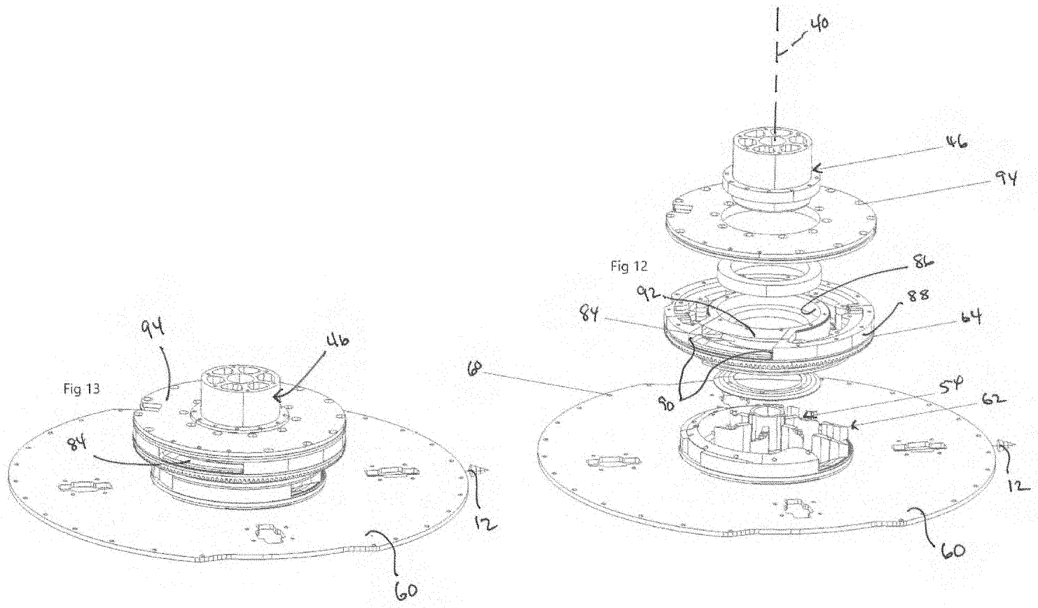

Referring now to FIGS. 12-13, the diffuser lid 64 is depicted as part of an assembly including the hub 46 and carousel impeller 54. The diffuser lid 64 includes a return port 84 formed therein, and which may receive excess fluid from the primary fluid movement circuit and route the fluid toward the main reservoir (e.g., the lower reservoir). The diffuser lid 84 may be a generally annular structure having an inner wall 86 and an outer wall 88, both of which may extend around the central axis 40, with the inner wall 86 defining a central diffuser lid opening. The return port 84 is formed in the diffuser lid 64 and extends between the inner wall 86 and the outer wall 88 to allow fluid to flow through the return port 84 to the diffuser lid opening. The return port 84 may be defined by a pair of sidewalls 90, each of which extend between the inner wall 86 and the outer wall 88, as well as an intermediate surface 92, which extends in a radial direction between the inner wall 86 and the outer wall 88, and in an angular direction between the pair of sidewalls 90. In the assembled view depicted in FIG. 13, the return port 84 can be seen, with a diffuser cap 94 enclosing the return port 84 (e.g., the diffuser cap 94 may partially define the return port 84, along with the diffuser lid 64).

The diffuser lid 64 may be connected to the rack gear 66, or may be integrally formed with the rack gear 66, with the rack gear 66 being generally annular in configuration and including a plurality of gear teeth that extend toward the middle plate 60. The rack gear 66 is configured to interface with several gears associated with several vessels to cause rotation of the vessels about respective vessel axes as the vessels move within the shell 14 about the central axis 40, as will be explained in more detail below.

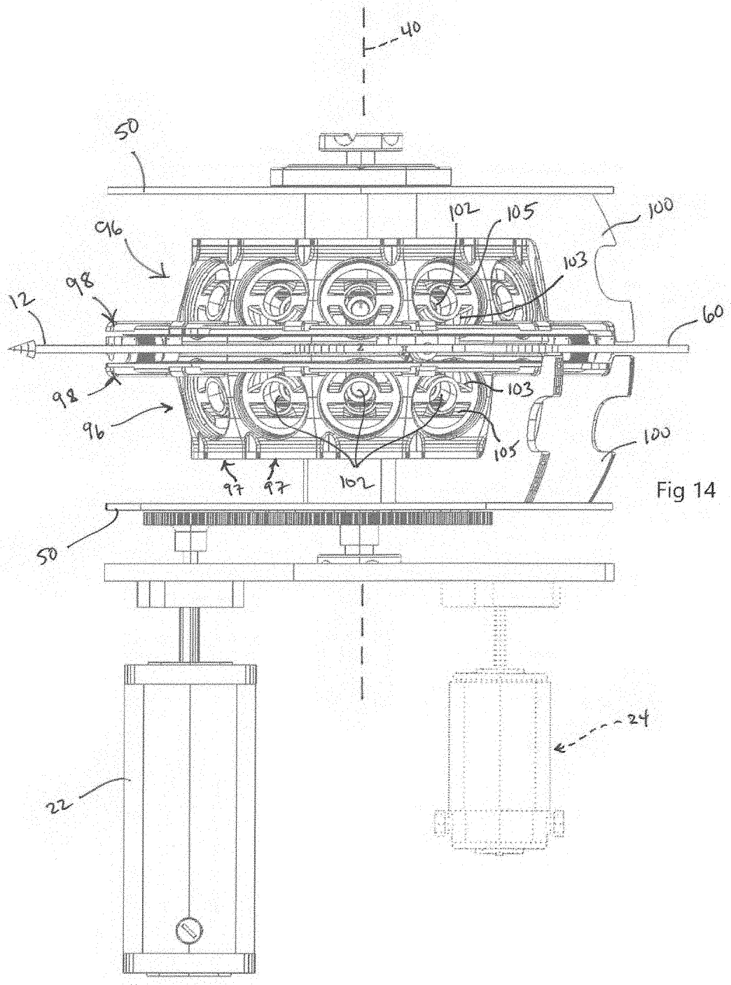

Referring now to FIG. 14, there is depicted a side view of the pump assembly 10 with various external components (e.g., the outer shell 14) having been removed to illustrate a pair of internal carousels hubs 96, a pair of ring gears 98, and a plurality of spokes 100. FIG. 14 includes three spokes 100, while several additional spokes have not been shown to more clearly show the carousel hubs 96. From the perspective shown in FIG. 14, the pump assembly 10 includes an upper carousel hub 96 and a lower carousel hub 96, both of which rotate about the central axis 40, in opposite directions relative to each other, as will be described in more detail below. Each carousel hub 96 is configured to engage with a plurality of vessels to drive the vessels in a circular path around the central axis 40.

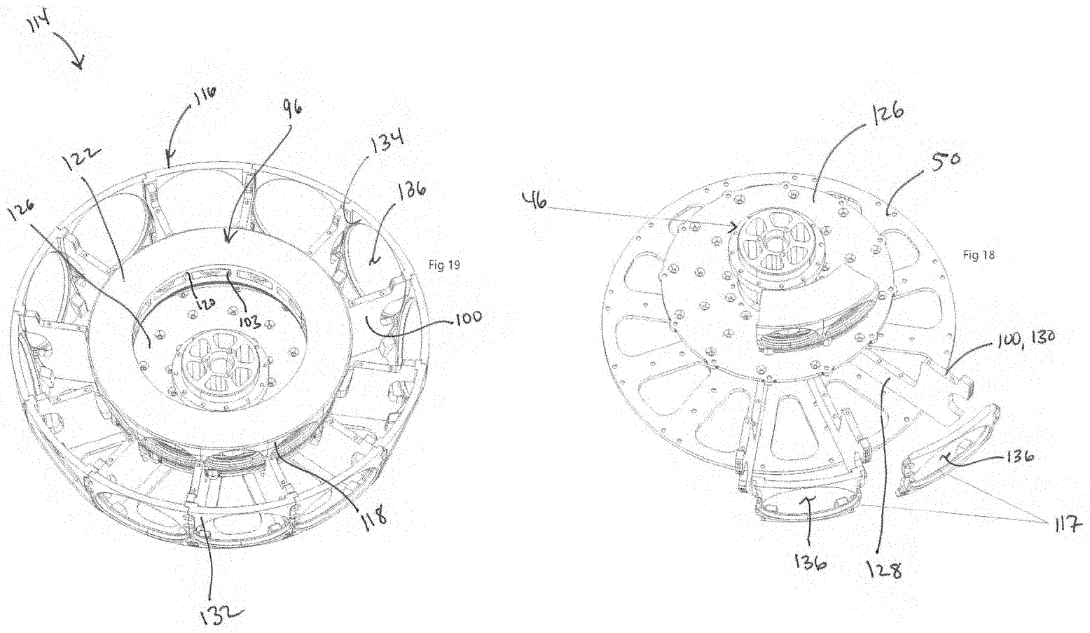

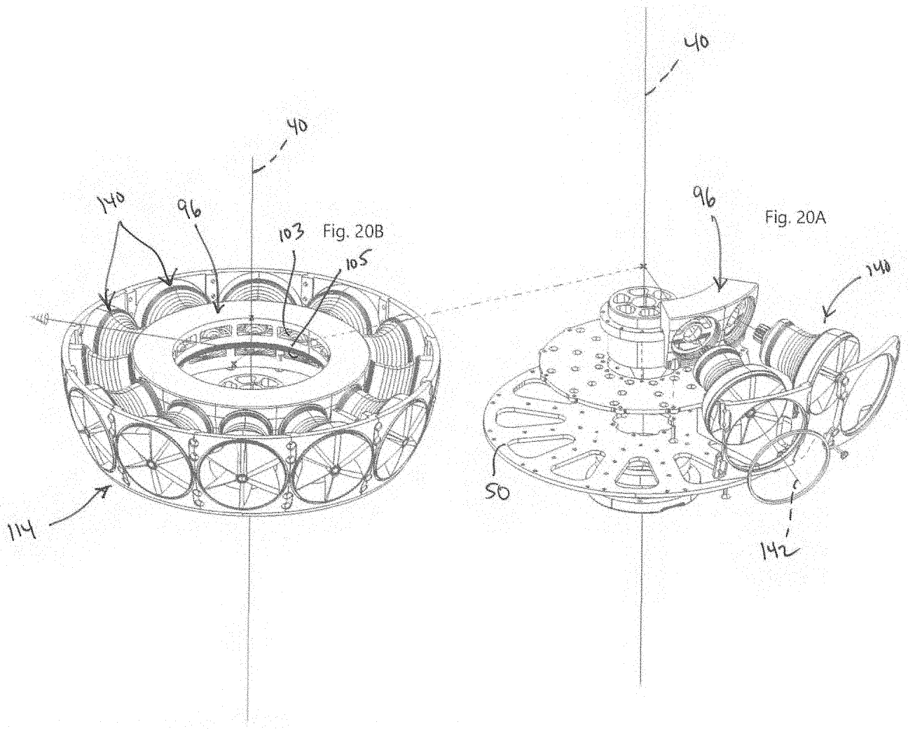

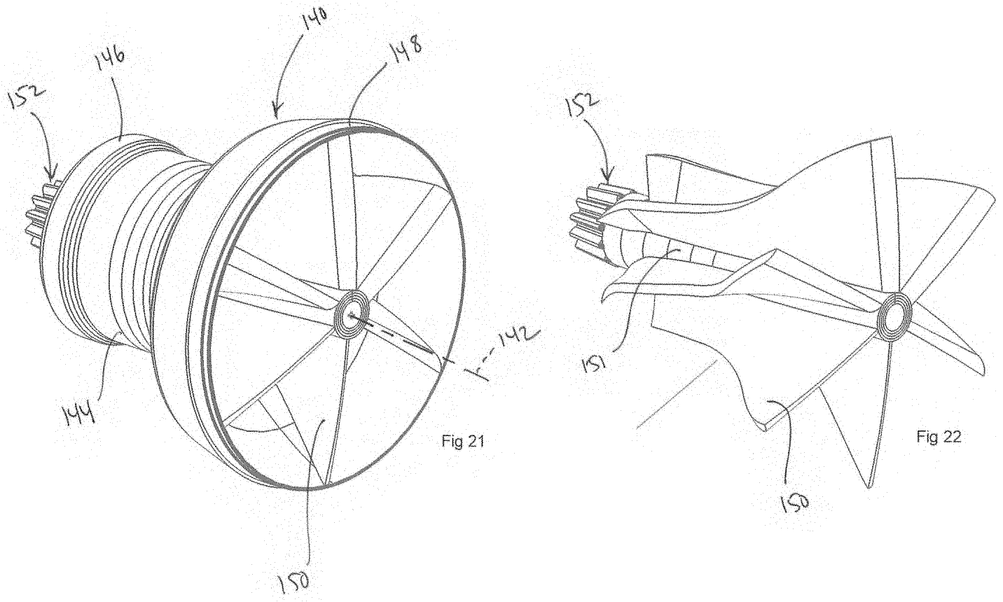

In more detail, FIG. 14 depicts the lower carousel plate 50 and the corresponding upper carousel plate 50, with the carousel plates 50 being arranged on opposite sides of the middle plate 60. Each carousel hub 96 is a generally annular structure extending about the central axis 40 and includes a plurality of hub central openings 102, a plurality of hub feed ports 103, and a plurality of hub overflow ports 105. The plurality of hub central openings 102 extend from an outer face of the carousel hub 96 toward the central axis 40 and are configured to facilitate engagement with a respective vessel. Each hub central opening 102 may extend around a hub opening axis that extends in one direction toward the central axis 40 and in another direction toward the middle plate 60. The hub feed ports 103 are configured to supply fluid to vessels located within the primary fluid circuit, while the hub overflow ports 105 are configured to receive fluid from vessels located within the primary fluid circuit. Additional details related to the carousel hub 96 will be described in more detail below in connection with FIGS. 18-19.

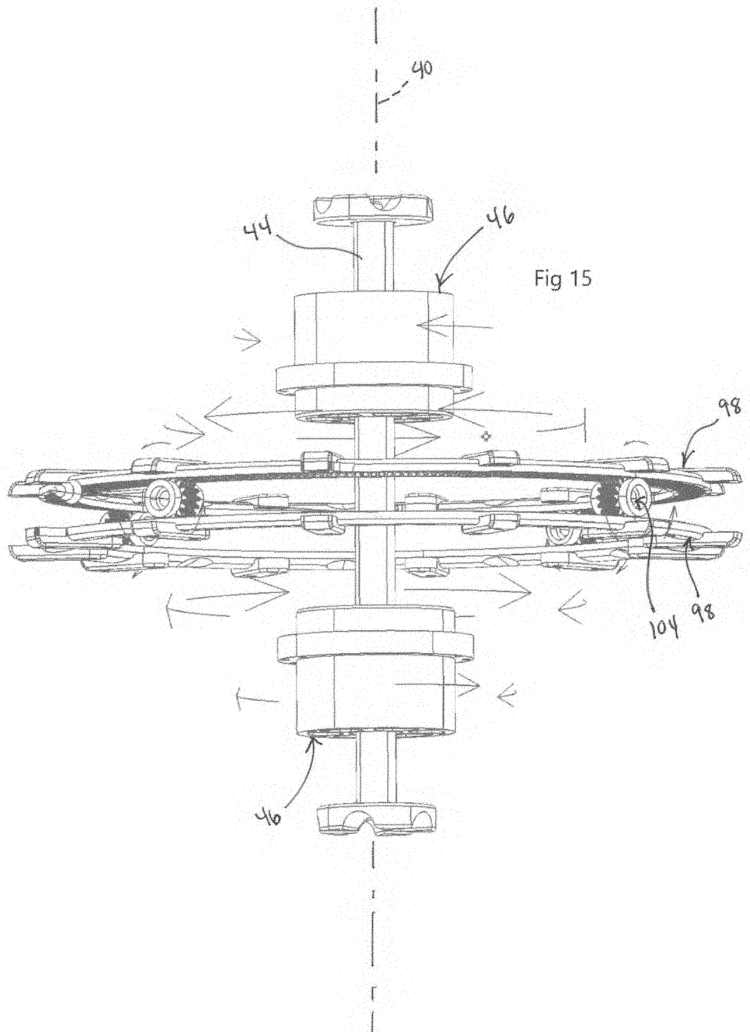

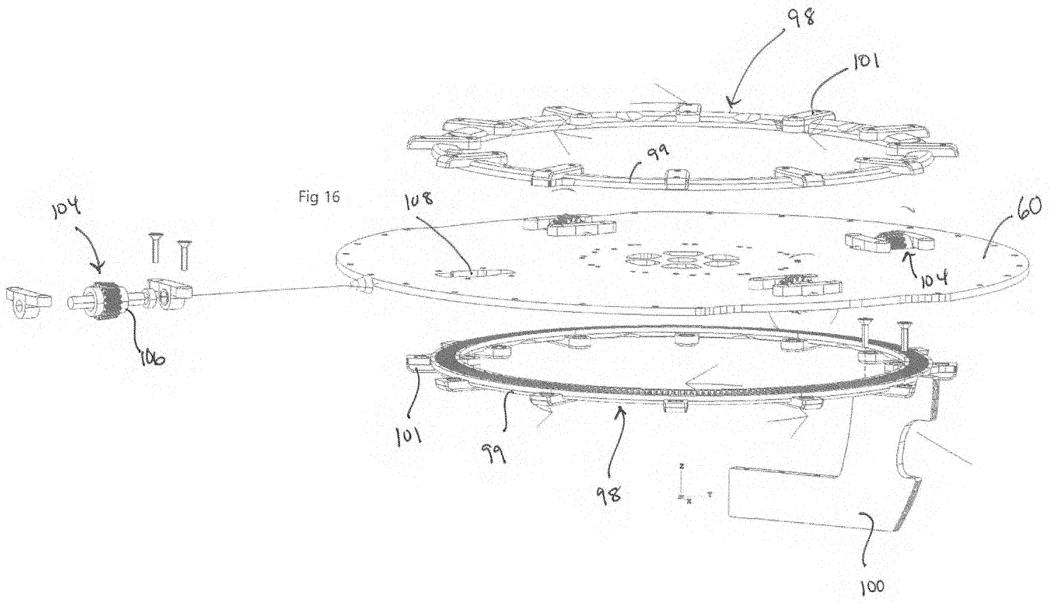

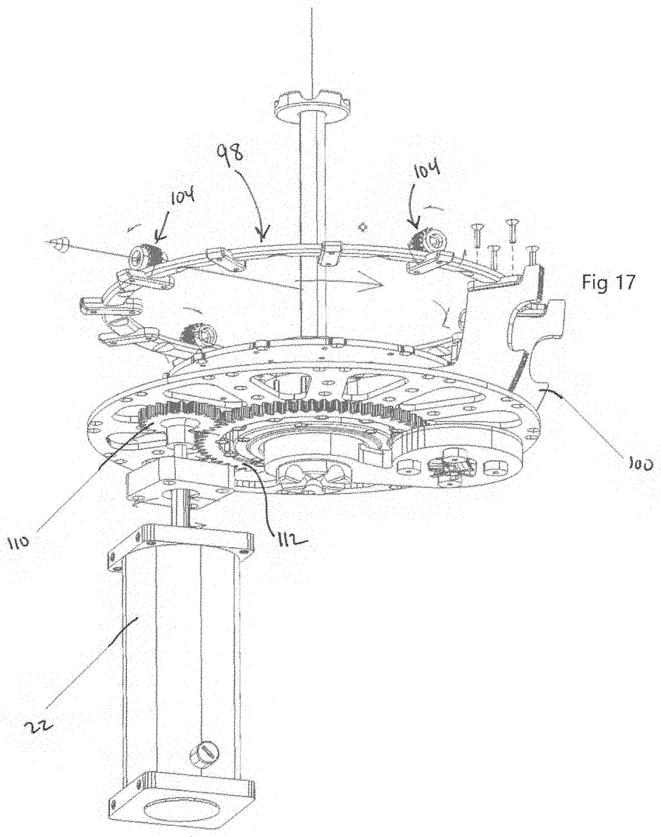

As noted above, the carousel hubs 96 rotate in opposite directions relative to each other. Thus, to facilitate the opposite rotation of the carousel hubs 96, one embodiment of the pump assembly 10 includes the ring gears 98 depicted in FIGS. 15-17. Each ring gear 98 includes an annularly shaped main body 99 having gear teeth formed on one side thereof. The ring gear 98 may also include a plurality of spoke mounts 101 coupled to the main body 99 and configured to engage with a respective one of the spokes 100.

The pair of ring gears 98 are operatively connected to each other via a plurality of idler gears 104, which are configured to convert rotation of a first ring gear 98 in a first rotational direction into rotation of a second ring gear 98 in a second rotational direction opposite the first rotational direction. Each idler gear 104 may include a generally cylindrical body 106 having a plurality of external gear teeth formed thereon. FIG. 15 shows the pair of ring gears 98 coupled to the idler gears 104. The hubs 46 are also shown with arrows to depict the opposite rotation of the hubs 46, which is made possible by the interaction of the ring gears 98 and idler gears 104. The return tube 44 is also shown in FIG. 15 as passing through both hubs 46 and ring gears 98, and it should be noted that both hubs 46 rotate around the return tube 44; the return tube 44 does not serve as a rotation axle.

The idler gears 104 may be rotatably coupled to the middle plate 60 and rotate about respective rotation axis that may be generally perpendicular to the central axis 40. The middle plate 60 may include a plurality of openings 108 sized to receive a respective idler gear 104. The openings 108, and the corresponding idler gears 104, may be equally spaced about the central axis 40 to distribute the load transfer between the ring gears 98 and the idler gears 104.

The ring gears 98 may be driven by the drive motor 22 through intervening structural connections. In more detail, and referring now specifically to FIG. 17, the drive motor 22 is connected to a drive gear 110, such that when the drive motor 22 is actuated, the drive motor 22 imparts a force on the drive gear 110 to rotate the drive gear 110. Meshed with the drive gear 110 is a transfer gear 112, such that rotation of the drive gear 110 imparts a force on the transfer gear 112, which causes the transfer gear 112 to rotate. The transfer gear 112 is mounted to the lower carousel plate 50, such that the lower carousel plate 50 rotates with the transfer gear 112. As noted above, the lower carousel plate 50 is mounted to the lower hub 46, which is in turn, mounted to the lower carousel impeller 54. Thus, as the lower carousel plate 50 rotates, so does the lower hub 46, which in turn causes rotation of the lower carousel impeller 54.

Referring again to FIGS. 14 and 15, the lower carousel plate 50 is additionally connected to the lower ring gear 98 via the spokes 100, with the lower ring gear 98 being meshed with the plurality of idler gears 104 rotatably coupled to the middle plate 60. The idler gears 104 are additionally meshed to the upper ring gear 98, in opposed relation to the lower ring gear 98, with the upper ring gear 98 being connected to upper spokes 100. The upper spokes 100 are connected to the upper carousel plate 50, which is connected to the upper hub 46, which is in turn connected to the upper carousel impeller 54. Accordingly, as the lower carousel impeller 54 rotates in a first rotational direction, the lower ring gear 98 also rotates in the first rotational direction, which causes rotation of the idler gears 104 about a rotation axis that is generally perpendicular to the rotation axis of the lower ring gear 98. The meshed connection between the idler gears 104 and the upper ring gear 98 results in rotation of the upper ring gear 98 in a second rotational direction opposite the first rotational direction of the lower ring gear 98 (i.e., the upper ring gear 98 and the lower ring gear 98 rotate in opposite directions). The interconnection between the upper ring gear 98 and the upper carousel impeller 54 causes the upper carousel impeller 54 to rotate with the upper ring gear 98. The upper carousel impeller 54 is connected to the upper hub 46, which is in turn connected to the upper carousel plate 50. Therefore, as the upper carousel impeller 54 rotates, the upper hub 46 also rotates with the upper hub 46, along with the upper carousel plate 50.

The rotation of the various components described above facilitates rotation of several vessels (see FIG. 20B), which move within the primary fluid circuit, and are selectively filled with fluid as they enter the primary fluid circuit, and emptied with fluid as they leave the primary fluid circuit. Each vessel may be primarily filled with fluid received from the fluid transfer body 20, and secondarily filled or topped off with fluid received in response to exposure to the diffuser The vessels are carried within a carousel 114, with the pump assembly 10 including a pair of carousels 114 (e.g., an upper carousel 114 and a lower carousel 114) that facilitate movement of the vessels and which rotate in opposite directions relative to each other.

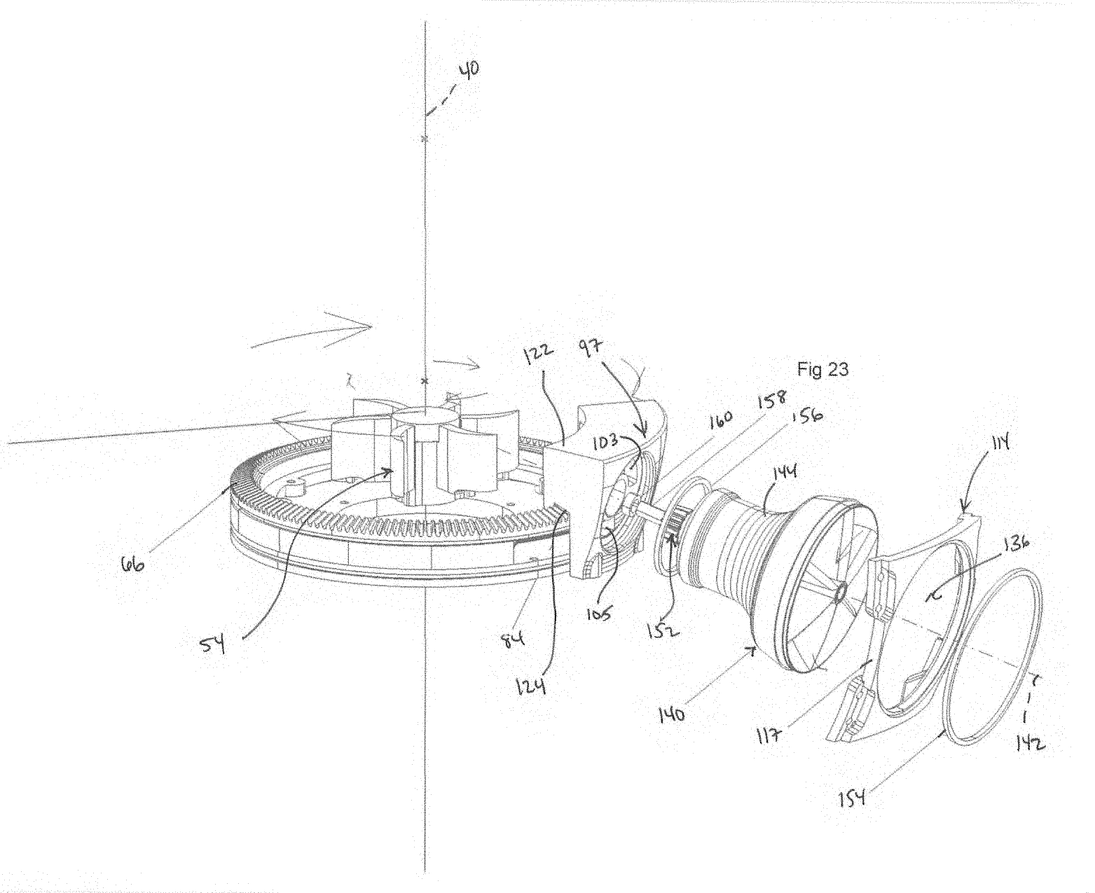

An assembled carousel 114 is shown in FIG. 19. Each carousel 114 may include a carousel hub 96, a plurality of spokes 100, and a vessel frame 116, which may collectively define a carousel frame (e.g., pumping frame) which moves as a single unit or assembly. The carousel hub 96 includes a plurality of openings 102 (see FIG. 14), hub feed ports 103, and hub overflow ports 105, as noted above, and may be formed by a plurality of separate hub bodies 97, each having a single opening 102, a single hub feed port 103, and a single hub overflow port 105, or alternatively, the carousel hub 96 may be formed as a single integral body. In both instances, the carousel hub 96 may define an outer face 118 (see FIG. 19), an inner face 120, and a planar surface 122 extending between the outer and inner faces 118, 120. The portion of the carousel hub 96 opposite the planar surface 122 may include an annular groove 124 (see FIG. 23) formed therein, which may allow the carousel hub 96 to extend over rack gear 66.

The carousel hub 96 may be mounted to a support plate 126, which extends radially outward from the hub 46 in generally parallel relationship to the carousel plate 50. When the carousel hub 96 is mounted to the support plate 126, the planar surface 122 of the carousel hub 96 is spaced from, and is generally parallel to, the support plate 126.

The spokes 100 extend in an axial direction between the support plate 126 and the carousel plate 50, and in a radial direction relative to the central axis 40 toward an outer diameter of the carousel plate 50. Each spoke 100 may include a proximal portion 128 residing between the support plate 126 and the carousel plate 50 and a distal portion 130 extending radially outward beyond the support plate 126. The distal portion 130 may be enlarged relative to the proximal portion 128, such that the distal portion 130 extends from the carousel plate 50 by a greater distance at the distal portion 130 than the proximal portion 128.

The vessel frame 116 may form a complete ring and may be connected to the proximal portion 130 of the spokes 100 and may be positioned adjacent an outer diameter of the carousel plate 50. The vessel frame 116 may have an outer surface 132, an opposing inner surface 134, and a plurality of vessel frame openings 136 extending between the outer surface 132 and the inner surface 134. The outer surface 132 may be arcuate, and in one embodiment, partially spherical. The vessel frame openings 136 may be equally spaced about the vessel frame 116. In the exemplary embodiment, the vessel frame 116 includes twelve vessel frame openings 136, although the number of vessel frame openings 136 formed in the vessel frame 116 may be greater than twelve or less than twelve without departing from the spirit and scope of the present disclosure. The vessel frame 116 may be formed of individual vessel frame bodies 117 that collectively define the vessel frame 116. Each vessel frame body 117 may include a single vessel frame opening 136, and may be connected to a pair of spokes 100, as well as the adjacent vessel frame bodies 117.

Although the foregoing describes each carousel 114 as being comprised of several separate components that are assembled to form the carousel 114, it is contemplated that in other embodiments, the carousel 114 may be formed from a single unit of material, such as via three-dimensional printing or other techniques known by those skilled in the art.

Referring now to FIGS. 20A and 20B, each carousel 114 may be configured to carry or transport several rotating vessels/funnels 140. Each vessel 140 extends between the carousel hub 96 and the vessel frame 116. As the carousel 114 rotates about the central axis 40, the vessels 140 also rotate about the central axis 40. In addition, each vessel 140 is configured to rotate about a respective, radially extending vessel axis 142 that passes through the center of the vessel 140. The carousels 114 and the vessels 140 are sized to rotate within the shell 14 in close proximity to the inner surface of the shell 14. In this regard, the external curvature of the carousel 114 may be complementary to the curvature of the inner surface of the shell 14.

FIG. 21 is an upper perspective view of one embodiment of the vessel 140, which includes a primary body 144 disposed about the vessel axis and that includes a proximal end portion 146 and a distal end portion 148. The primary body 144 may include an outer wall that is generally conical and defines a circular cross section in a cross-sectional plane taken perpendicular to the vessel axis 142. The outer diameter of the primary body 144 may vary between the proximal end portion 146 and the distal end portion 148, with the diameter generally being smaller at the proximal end portion 146 than at the distal end portion 148. The external configuration of the primary body 144 may be specifically sized and adapted to provide clearance for structures external to the primary body 144, such as ring gears 98, which may be adjacent the primary body 144 between the proximal end portion 146 and the distal end portion 148. An inner surface of the outer wall may be generally smooth and extend between the proximal end portion 146 and the distal end portion 148. The inner diameter may define an inner surface that defines an inner diameter that varies between the proximal end portion 146 and the distal end portion 148, similar to the outer diameter.

The primary body 144 may additionally include a plurality of internal veins 150 that extend radially outward from a vein hub 151 toward the inner surface of the primary body 144. Each vein 150 may also extend substantially from the proximal end portion 146 to the distal end portion 148. The veins 150 may have a curvature to them, such that the vein 150 may extend by an angular amount around the vessel axis 142 as the vein 150 extends along its length, e.g., in a direction between the proximal end portion 146 and the distal end portion 148. The curvature may produce a concave face of the vein 150 and an opposing convex face of the vein 150.

As noted above, each vessel 140 is configured to rotate about its respective vessel axis 142, and thus, to facilitate such rotational movement of the vessel 140, the vessel 140 may include a geared shaft 152 (see FIG. 23) that is connected or connectable to the primary body 144, and which is configured to engage with a circular rack gear 66. In this regard, as the geared shaft 152 travels around the circular rack gear 66 as the carousel 114 rotates around the central axis 40, the interconnection between the circular rack gear 66 and the geared shaft 152 causes rotation of the geared shaft 152 relative to the circular rack gear 66. Furthermore, the interconnection between the geared shaft 152 and the primary body 144 causes the primary body 144 to rotate with the geared shaft 152. Thus, as the geared shaft 152 rotates as it travels along the rack gear 66, the primary body 144 also rotates with the geared shaft 152.

FIG. 23 is an upper perspective view showing a vessel 140 in alignment with a vessel frame opening 136 of a vessel frame body 117. The distal end portion 148 of the primary body 144 is positioned adjacent the vessel frame body 117, with the outer diameter the distal end portion 148, as may be defined by a distal-most rim or edge, being substantially equal, yet slightly less than the diameter of the vessel frame opening 136. As such, the distal-most rim or edge may be received within a circular recess or cavity formed in the vessel frame body 117 to align the vessel 140 with the vessel frame body 117. A seal 154 may be connected to the vessel frame body 117 to mitigate undesirable fluid flow between the vessel frame body 117 and the inner surface of the shell 14.

The geared shaft 152 extends through the carousel hub opening 102 to engage with the teeth on rack gear 66. FIG. 23 shows a single hub body 97 to illustrate the engagement between the hub body 97 and the rack gear 66. In particular, the rack gear 66 is received in annular groove 124 formed in the hub body 97. An inner seal 156 may be located between the hub body 97 and the vessel 140 to mitigate undesirable fluid flow therebetween. The geared shaft 152 may include an elongate shaft portion 158 that is received within a bearing 160 configured to reduce friction between the elongate shaft portion 158 and the hub body 97 as the elongate shaft portion 158 rotates relative to the hub body 97. The hub feed port 103 of the hub body 97 is axially aligned with the carousel impeller 54 so as to allow for placement of the hub feed port 103 in fluid communication with the carousel impeller 54 when the carousel 114 rotates. Furthermore, the hub overflow port 105 is axially aligned with the return port 84 so as to allow for placement of the hub overflow port 105 in fluid communication with the return port 84 when the carousel 114 rotates.

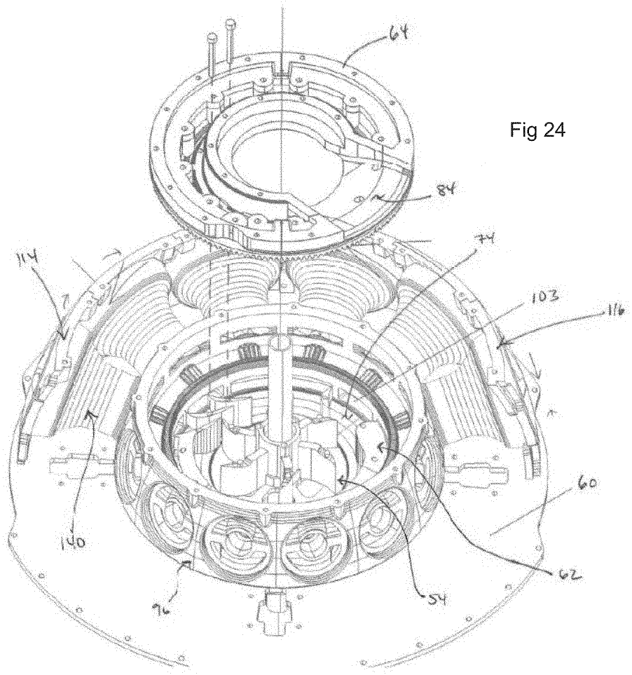

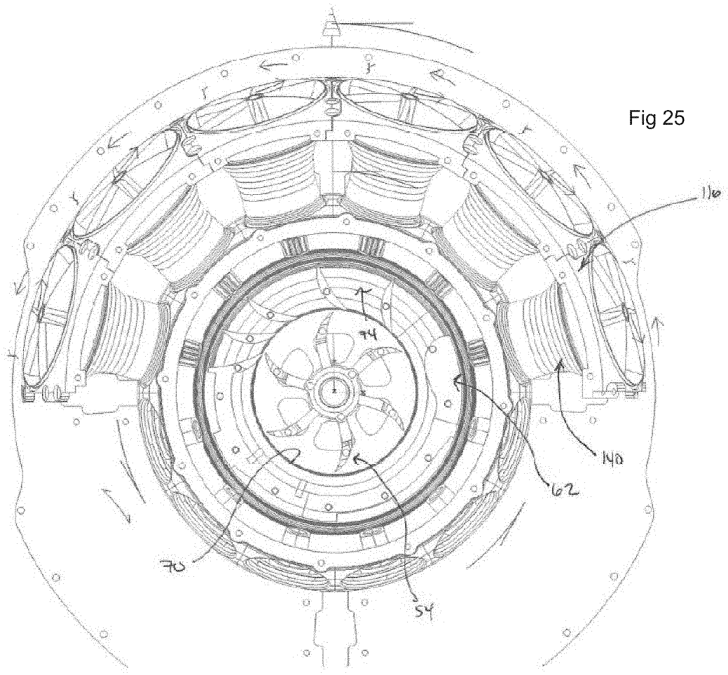

FIGS. 24 and 25 is showing a plurality of vessels 140 exposed to, or aligned with, the carousel impeller 54 via the diffuser passageways 74. Note that in the exemplary embodiment depicted in FIG. 24, six vessels 140 are exposed to the carousel impeller 54, while six additional vessels 140, which are not shown in FIG. 24 for purposes of clarity, are not exposed to the carousel impeller 54 due to the diffuser sidewall 70 blocking those vessels 140 from being in fluid communication with the carousel impeller 54. Arrows are also shown in FIG. 24 to illustrate a counterclockwise motion of the vessel frame 116 and the resulting synchronized rotation of the vessels 140.

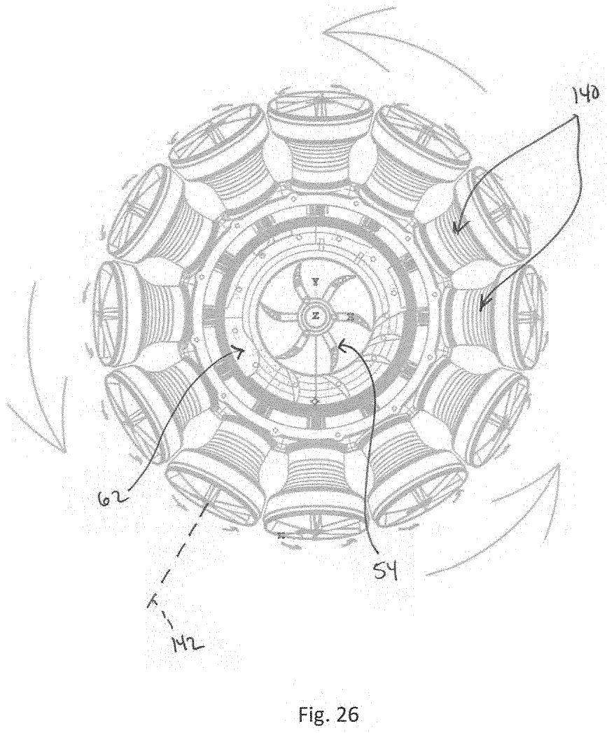

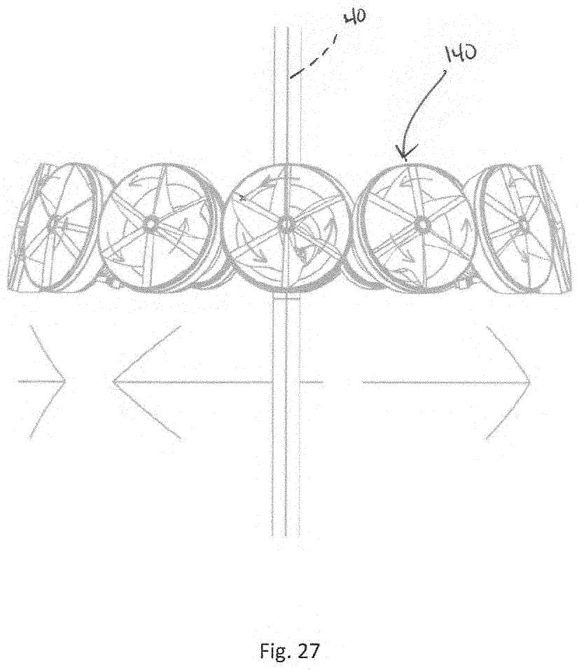

FIG. 26 shows a full set of vessels 140 within carousel 114, along with arrows depicting a direction of rotation of the carousel 114 and separate arrows depicting the synchronized rotation of the vessels 114. For instance, from the perspective shown in FIG. 26, the carousel 114 is rotating in a counterclockwise direction, while vessel 140a is rotating in a counterclockwise direction around its vessel axis 142. FIG. 27 shows the same carousel and vessels depicted in FIG. 26.

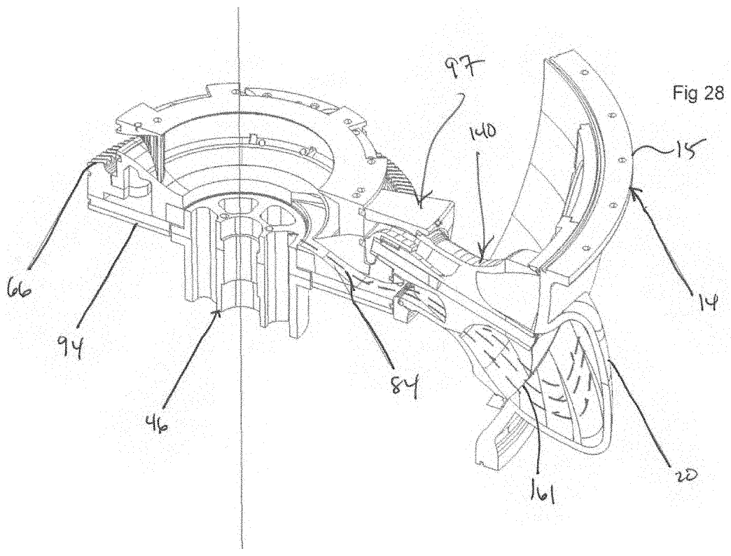

FIG. 28 is a cross sectional view illustrating a primary source of fluid filling a vessel 140. In particular, fluid is flowing from a fluid transfer outlet 161 of the fluid transfer body 20. An empty vessel 140 may be primarily filled when it is exposed to the fluid transfer outlet 161. Any excess fluid will flow through the hub overflow port 105 and then through the return port 84 of the diffuser base 62 to facilitate continuous flow or fluid movement. The center of the diffuser may be open to provide an area for a diffuser reservoir which receives fluid from the return port 84.

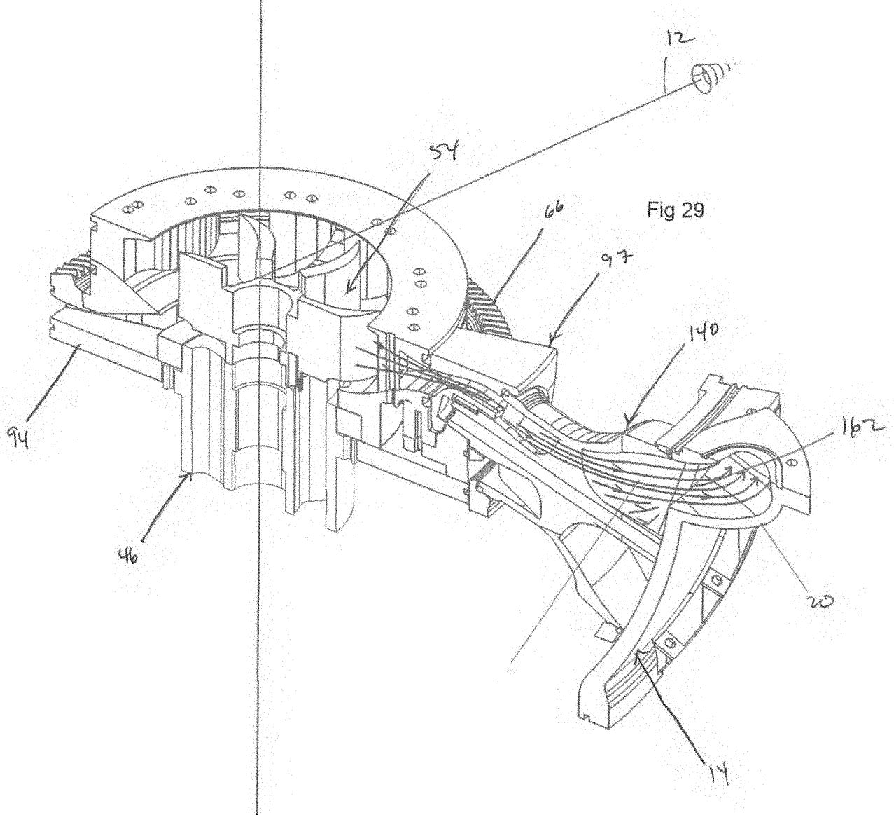

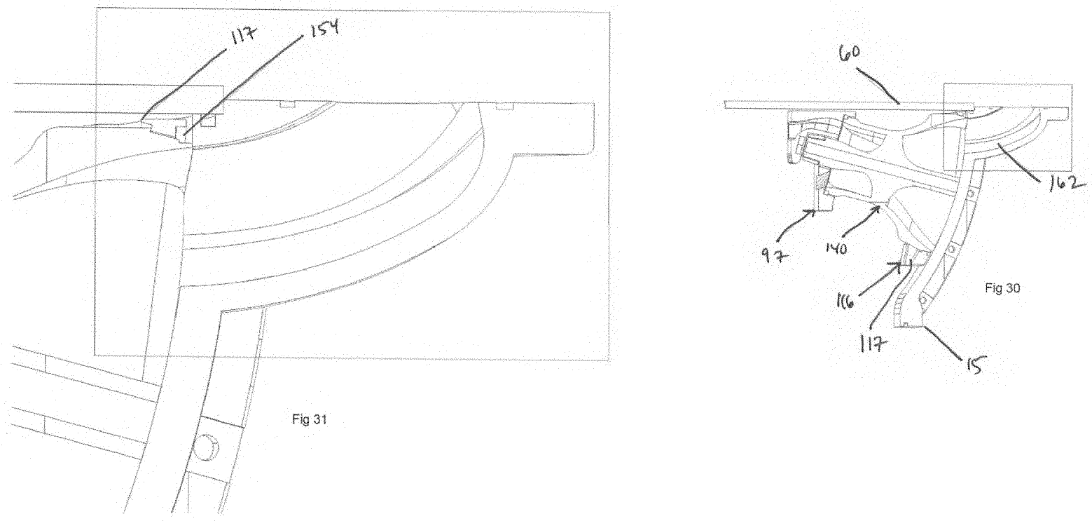

FIG. 29 is a cross sectional view illustrating discharge of fluid from a vessel 140 into a fluid transfer inlet 162 of the fluid transfer body 20. A full vessel 140 may be primarily emptied when the vessel 140 becomes aligned or exposed to the fluid transfer inlet 162.

The fluid transfer body 20 may be configured such that the passageway defined by the fluid transfer body 20 expands from the fluid transfer inlet 162 to the fluid transfer outlet 161. The expansion of the fluid transfer body 20 in the direction of flow is intended to slow the fluid down as the fluid flows from the fluid transfer inlet 162 to the fluid transfer outlet 161. As a result of the expansion, the area defined by the opening at the fluid transfer inlet 162 may be smaller than the opening defined by the fluid transfer outlet 161. In one particular embodiment, the opening defined by the fluid transfer outlet 161 is approximately twice as large as the area defined by the fluid transfer inlet 162.

FIGS. 30 and 31 illustrate the proximity of the main body 15 of the shell 14 and the vessel frame 116 (and vessel frame bodies 117) and vessels 140. FIG. 31 is an enlarged view of what is depicted in FIG. 30.

With the basic structure of the pump assembly 10 having been described above, the following discussion pertains to an exemplary use of the pump assembly 10, and in particular, the fluid movement within the pump assembly 10 during operation of the pump assembly 10. Upon initial startup, the centrifugal pump 24 is actuated to pump fluid from a main reservoir into the system to fill the vessels 140 located in the respective wet regions (e.g., the area within a given carousel 114 between the fluid inlet port communicating with that carousel and the fluid outlet port communicating with that carousel; also, those vessels 114 within the carousel 114 that are fluidly exposed to, or in fluid communication with, the carousel impeller 54). Actuation of the centrifugal pump 24 also causes the fluid transfer bodies 20 to be filled. When the fluid transfer bodies 20 are filled and the vessels 140 within the wet regions of the carousels 114 are filled, the pump assembly 10 may be considered to be primed.

Once the pump assembly 10 is primed, the drive motor 22 may be actuated, which causes rotation of the upper and lower carousels 114. Alternatively, it is contemplated that the priming of the pump assembly 10 and the actuation of the upper and lower carousels 114 may occur concurrently. The rotation of the upper carousel 114 and the lower carousel 114 creates a fluid movement path that forms an essentially closed loop, wherein fluid is carried by a portion of the vessels 140 in the upper carousel 114, then is emptied into a fluid transfer body 20 and is fed into the vessels 140 lower carousel 114. The fluid is carried by the lower carousel 114, then is emptied into a fluid transfer body 20 and is fed into the vessels 140 in the upper carousel 114. This cycle (upper carousel vessels, fluid transfer body, lower carousel vessels, fluid transfer body, etc.) continues while the pump assembly 10 remains on. The vessels 140 in both the upper and lower carousels 114 are not filled with fluid as they rotate all 360 degrees around the central axis 40. Rather, the vessels 140 are filled, and then emptied as they vessels 140 travel less than 360 degrees, and in some embodiments, less than 270 degrees, and in some other embodiments, approximately 180 degrees. Assuming filling of the vessels 140 begins at one point that is 180 degrees from another point where the vessels 140 are emptied, one 180-degree region of the 360-degree range of motion of the vessels 140 relative to the central axis 40 may be referred to as a wet region, while the other 180-degree region may be referred to as a dry region.

Referring now to FIG. 32, the fluid transfer body 20 has been removed for purposes of illustration, and the fluid flow within the fluid transfer body 20 has been depicted in dotted lines. The fluid from the fluid transfer body 20 is flowing into the vessels 140 of the upper carousel 114 and is received within the cavities of the spinning vessels 140. In particular, the fluid transfer body 20 and the vessels 140 may be configured to allow for emptying of the fluid flow from the fluid transfer bodies 20 into only some of the cavities within a given vessel 140 at any given moment in time. In other words, all of the cavities are not exposed to the fluid transfer body 20 at the same time. Rather, one cavity may be exposed to the fluid transfer body 20, and then rotation of the vessel 140 and the carousel 114 may cause another cavity to be exposed to the fluid transfer body 20, and so forth. Thus, the rotation of the vessels 140 about the vessel axis 142 and the central axis 40 sequentially aligns the cavities within the vessel 140 with the fluid transfer body 20 to allow for filling of the vessel cavity.

As the fluid is carried by the filled vessels 140, the vessels 140 are carried by the carousel 114 along a circular path about the central axis 40 from the fluid transfer outlet 161 to the fluid transfer inlet 162. The fluid carried by the vessels 140 moves along an arcuate segment that may define an angular dimension equal to 180 degrees, greater than 180 degrees or less than 180 degrees. In addition, while the vessels 140 are carried in the circular path, the vessels 140 additionally rotate about their respective vessel axis 142.

When the vessels 140 reach the fluid transfer inlet 162, the vessel cavities are sequentially emptied into the fluid transfer body 20 in a similar manner to how the vessels 140 are filled. The fluid flowing or moving within the pump assembly 10 generates forces, which may be desirable to a user. In particular, the arcuate or semi-circular fluid movement associated with movement of the fluid from the fluid transfer outlet 161 (wherein the vessels 140 are filed) to the fluid transfer inlet 162 (wherein the vessels 140 are emptied) within a given carousel 114 may generate a centrifugal force, F, wherein the magnitude of the centrifugal force may be equal to:

$$F = \frac{m {ν}^{2}}{r}$$

wherein m refers to the center of mass of the fluid in a vessel, v refers to the velocity of the fluid, and r refers to the radius of the path along which the fluid moves. The direction of the centrifugal force would be along an axis that is perpendicular to the central axis 40 and which is approximately equidistant from the two fluid transfer inlets 162 or the two fluid transfer outlets 161.

The upper carousel 114 and the lower carousel 114 each generate a respective centrifugal force, in view of their distinctive fluid transfer paths. The magnitude of the centrifugal force associated with the upper carousel 114 is approximately equal to the magnitude of the centrifugal force associated with the lower carousel 114. The centrifugal forces may be desirable to urge the pump assembly 10 in the direction of the centrifugal forces.

In addition to the centrifugal forces described above, there may be additional forces generated during operation of the pump assembly 10 that may contribute or aid in urging the pump assembly 10 toward a prescribed direction. In particular, each vessel 140 includes a plurality of vessel cavities 141 which sequentially expel or exhaust fluid from the vessel 140 toward a fluid transfer inlet 162 as the vessel cavities 141 become sequentially aligned or exposed to the fluid transfer inlet 162. During the exhausting process, one or more cavities 141 within the vessel 140 may be dry or contain no fluid, since the fluid from those cavities 141 has been exhausted, while one or more cavities 141 within the vessel 140 may still include fluid. Thus, the sequential exhausting of the fluid from the vessel cavities 141 into the fluid transfer inlet 162 may create a mass imbalance with regard to the exhausting vessel 140, e.g., the mass of the vessel 140 and fluid on one side of the vessel 140 being greater than the mass of the vessel 140 and fluid on the other side of the vessel 140. Furthermore, with the vessel 140 continuously rotating about its respective vessel axis 142, the pump assembly 10 may be configured to generate a positive force directed toward a prescribed direction as a result of the imbalanced vessel 140 rotating about its vessel axis 142. In particular, the portion of the vessel 140 that is of a larger mass may rotate toward the prescribed direction, while the portion of the vessel 140 that is of a lesser mass may rotate away from the prescribed direction. The imbalance in mass with regard to that vessel 140 may generate a force that contributes toward urging the pump assembly 10 toward the prescribed direction. The maximum amount of imbalance may be created when half of the vessel cavities 141 are filled with fluid, while the other half of the vessel cavities 141 do not include fluid. This half-filled, half-empty configuration may occur during both filling of the vessel 140 and exhausting of the vessel 140.

Yet another positive force that may be generated during operation of the pump assembly 10 is a Coriolis force associated with fluid being exhausted from the vessels 140 into the fluid transfer bodies 20. According to one embodiment, the fluid exhausted from the vessels 140 into the fluid transfer bodies 20 will have been caned along an arcuate path by the vessels 140 and then discharged into the fluid transfer bodies 20 in a radially outward direction. In particular, the portion of the fluid transfer bodies 20 that receives the fluid from the vessels 140 is positioned radially outward relative to a radius associated with the arcuate segment defined by the vessel rotation about the central axis 40. Thus, as the fluid flows radially outward from a smaller radius to a larger radius, the fluid is accelerated, and thus, generates a force associated with such acceleration. Due to the configuration of the pump assembly 10, the direction of the force may be toward the prescribed, desired direction. In one particular embodiment, with the pump assembly 10 including a first set of vessels 140 which carry fluid along a first arcuate segment in a first rotational direction, and a second set of vessels 140 which carry fluid along a second arcuate segment in a second rotational direction, the forces associated with the fluid being exhausted from a smaller radius to a larger radius may be generated on opposite sides of the pump assembly 10, with both forces being directed toward the prescribed direction, and thus, both contributing toward urging the pump assembly 10 toward that prescribed direction.

Although several forces may contribute to urging the pump assembly 10 toward a particular direction, there may be negative or counteracting forces associated with the fluid movement within the pump assembly 10. Similar to the vessel 140 sequentially exhausting fluid into a fluid transfer body 20, a vessel 140 may also sequentially receive fluid from a fluid transfer body 20 one cavity 141 at a time. The sequential receiving of fluid into the vessel 140 may result in a portion of the vessel 140 having already received fluid, while the remaining portion of the vessel 140 has not yet received fluid. Therefore, a mass imbalance may be created. The portion of the vessel 140 that is of a greater mass may be accelerated around the vessel axis 142 away from the prescribed direction, which works against the forces trying to move the pump assembly 10 toward the prescribed direction.

Some of the undesirable forces may be mitigated or neutralized by the rotation of the vessels 140. In particular, when the vessels 140 in the upper carousel 114 receive fluid from the fluid transfer outlet 161, the vessels 140 generally receive the fluid at the top of their rotation, and thus, the increased weight of the now-loaded vessel as the fluid rotates downwardly generates a vessel centrifugal force that is directed in a first direction. This vessel centrifugal force is counteracted by the motion and fluid transfer associated with the vessels of the lower carousel 114. In particular, as the vessels 140 unload fluid into the fluid transfer inlet 162, fluid may be exhausted from the vessels 140 adjacent the upper portion of the vessel 140, and thus, after half of the vessel 140 has been unloaded, the rotation of the loaded portion of the vessel 140 creates a vessel centrifugal force having a magnitude similar to the centrifugal force noted above in relation to the upper carousel 114 and in a direction that is opposite the first direction.

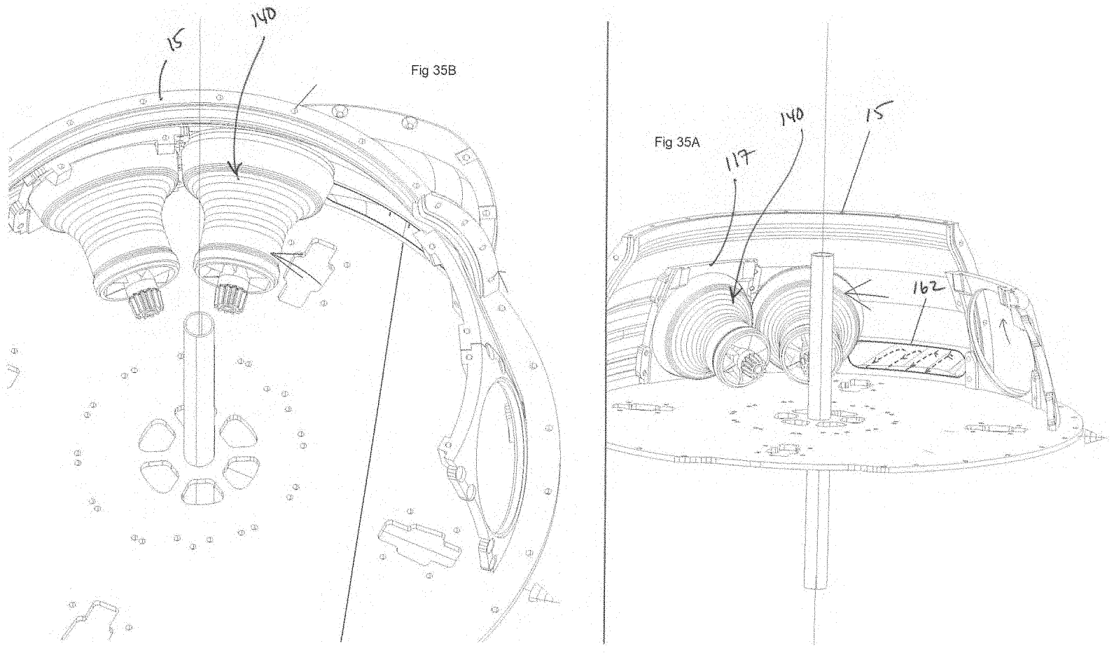

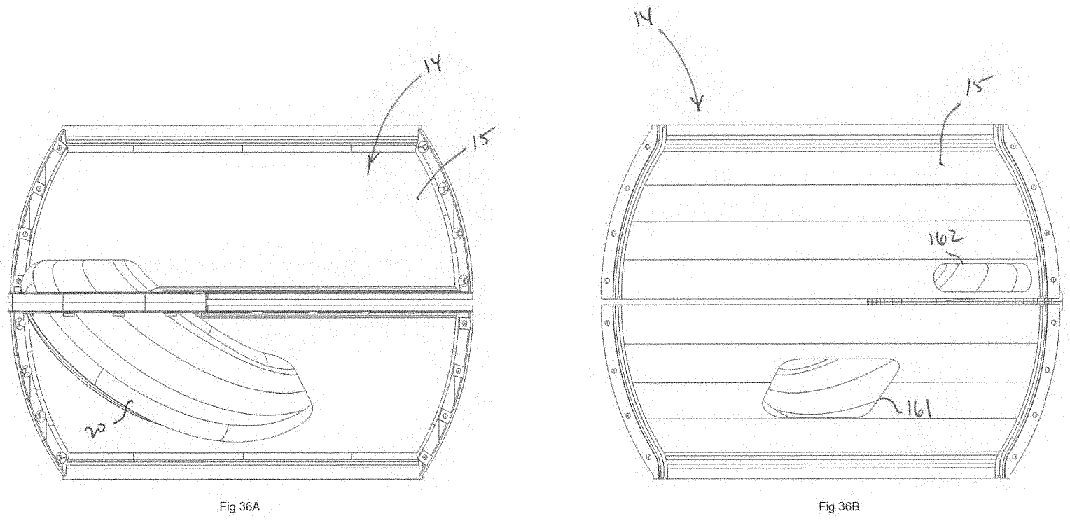

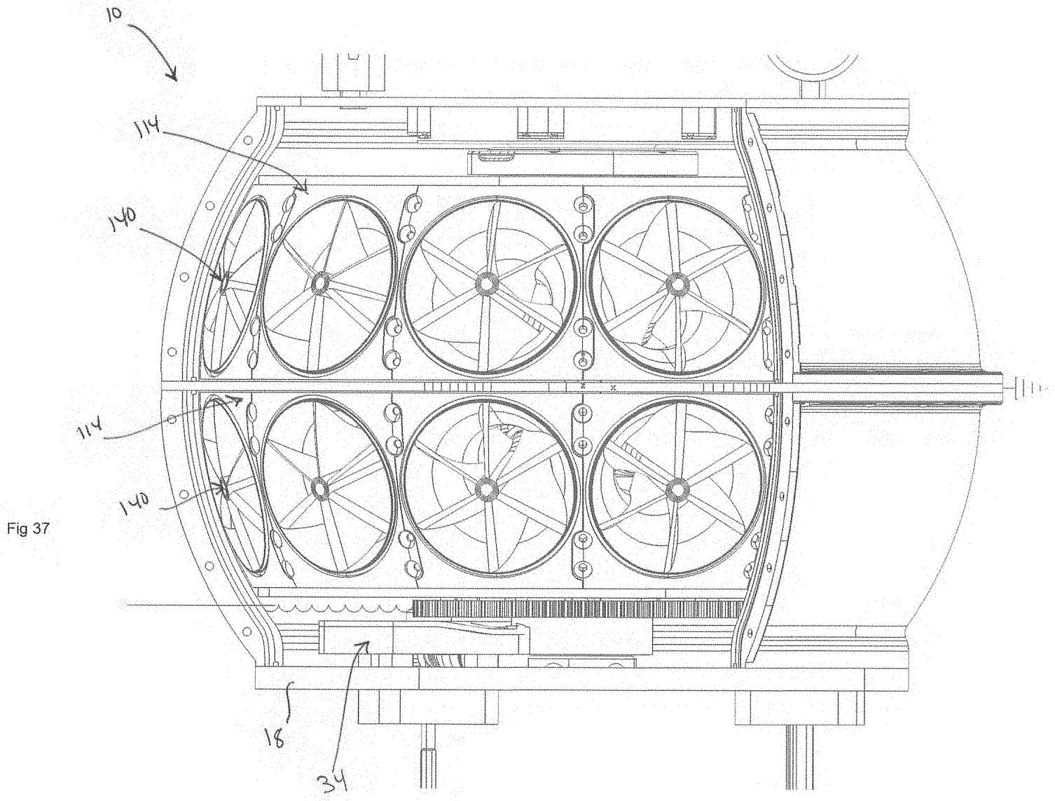

FIGS. 33A-C are a depiction illustrating primary filling and draining of the vessels 140, as well as rotation of the carousels 114 (not shown in FIGS. 33A-C, although their respective directions of rotation are represented by arrows 143 and 145), and rotation of the vessels 140. The carousel 114 carrying the upper set of vessels 140 from the perspective of FIG. 33A being referred to as the upper carousel and the carousel 114 carrying the lower set of vessels 140 from the perspective of FIG. 33A being referred to as the lower carousel. Arrow 143 is a representation of a rotational direction of the front side of upper carousel 114 (as exemplified by arrow 143 extending in front of reference field 135), which from the perspective shown in FIG. 33A is moving in a left-to-right direction. Arrow 145 is a representation of a rotational direction of the back side side of lower carousel 114, which from the perspective shown in FIG. 33A is moving in a left-to-right direction, and thus, the front side of the lower carousel 114 would be moving in right-to-left direction.

The upper vessels 140 carried by upper carousel 114 are rotating about their respective vessel axes 142 in a counterclockwise direction, when viewed from a radially outside position (e.g., viewing the vessels 140 toward the central axis 40. Similarly, the lower vessels 140 carried by the lower carousel 114 are rotating about their respective vessel axes 142 in a counterclockwise direction. Note that not all vessels 140 included in each carousel 114 are shown; rather, only those vessels 140 that are being filled or emptied based on their alignment with the fluid transfer bodies 20 have been depicted. From the perspective shown in FIG. 33A, the upper vessels 140 receive fluid from the left fluid transfer body 20, and exhaust fluid into the right fluid transfer body 20, while the lower vessels 140 receive fluid from the right fluid transfer body 20 and exhaust fluid into the left fluid transfer body 20.

The particular location of the vessel cavities 141 as they receive fluid from the fluid transfer body 20 and exhaust fluid to the fluid transfer body 20 may serve to optimize desired force generation within the pump assembly 10. Furthermore, the timing/synchronization of the combined rotation of the carousels 114 and the rotation of the vessels 140 optimizes the relative velocity of the vessel 140 from the perspective of the fluid transfer body 20 to optimize force generation and fluid transfer between the vessel 140 and the fluid transfer body 20.

When fluid is received into a vessel cavity 141 from the fluid transfer outlet 161, the direction of rotation of the about-to-be-filled vessel cavity 141 about the vessel axis 142 is substantially opposed to the direction of rotation of the carousel 114, while the direction of rotation of the about-to-be emptied vessel cavity about the vessel axis 142 is substantially aligned or similar to the direction of rotation of the carousel 114.

Referring to FIG. 33B, and specifically vessel 140a, the direction of rotation of vessel cavity 141a in its exhausting position is in the direction of arrow 147, which is generally aligned or similar to that of arrow 143, representing movement of the upper carousel 114. Similarly, with regard to the lower carousel 114, and specifically vessel 140b, the direction of rotation of vessel cavity 141b in its fill position is in the direction of arrow 149, which is generally opposite that of arrow 145. Thus, due to the then counter-acting rotation of the vessel cavity 141b relative to the rotation of the lower carousel 114, as represented by arrow 145, during the time the vessel cavity 141b is aligned with the fluid transfer outlet 161, the remainder of lower carousel 114 appears to be moving at a greater velocity than the vessel cavity 141b when viewed from the perspective of the fluid transfer outlet 161.

Similarly, with regard to the lower carousel 114, and referring now to FIG. 33C, the direction of rotation of vessel cavity 141b in its emptying position is in the direction of arrow 151, which is generally similar as that of arrow 145. Thus, due to the then similarly-directed rotation of the vessel cavity 141b relative to the rotation of the lower carousel 114, during the time the vessel cavity 141b is aligned with the fluid transfer inlet 162, the vessel cavity 141b appears to be moving at a greater velocity than the carousel 114 when viewed from the perspective of the fluid transfer inlet 162. With regard to the upper carousel 114, and specifically vessel 140a, the direction of rotation of vessel cavity 141a in its fill position is in the direction of arrow 153, which is generally opposite that of arrow 143.

Thus, on balance, the vessel centrifugal forces offset each other, and the remaining centrifugal forces associated with the arcuate movement of fluid from the fluid transfer inlets toward the fluid transfer outlets generates a force which urges the pump assembly 10 in a prescribed direction.

Although the foregoing discusses filling and emptying of the vessels 140 during operation of the pump assembly 10, it is understood that the vessels 140 may not be completely filled or completely emptied. For instance, when the vessels 140 are emptied, a film of the fluid may be present on the vessel 140.

The foregoing discussion and the embodiment depicted in FIGS. 1-37 are simply one exemplary embodiment. Along these lines, it is contemplated that one or more components of the pump assembly 10 may have alternative embodiments that additionally fall within the scope of the present disclosure. The following discussion relates to certain alternative embodiments for various components of the pump assembly 10.

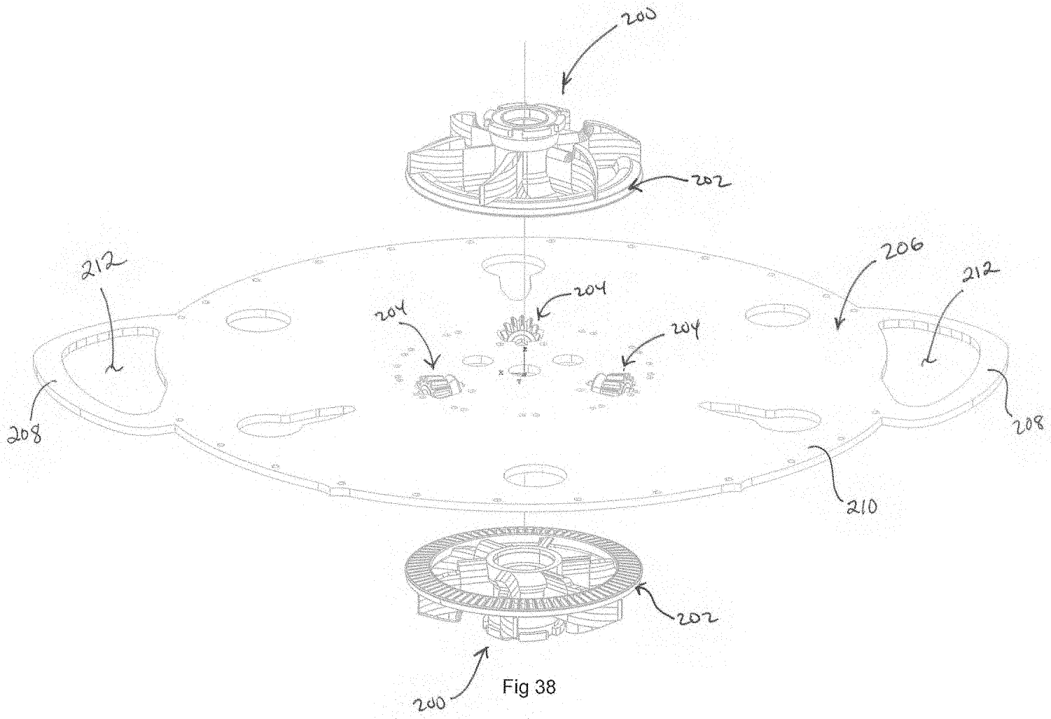

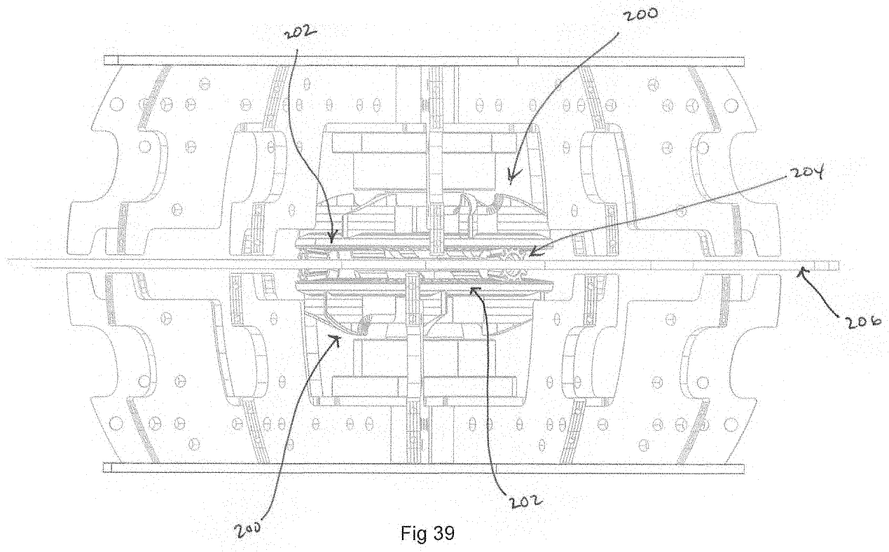

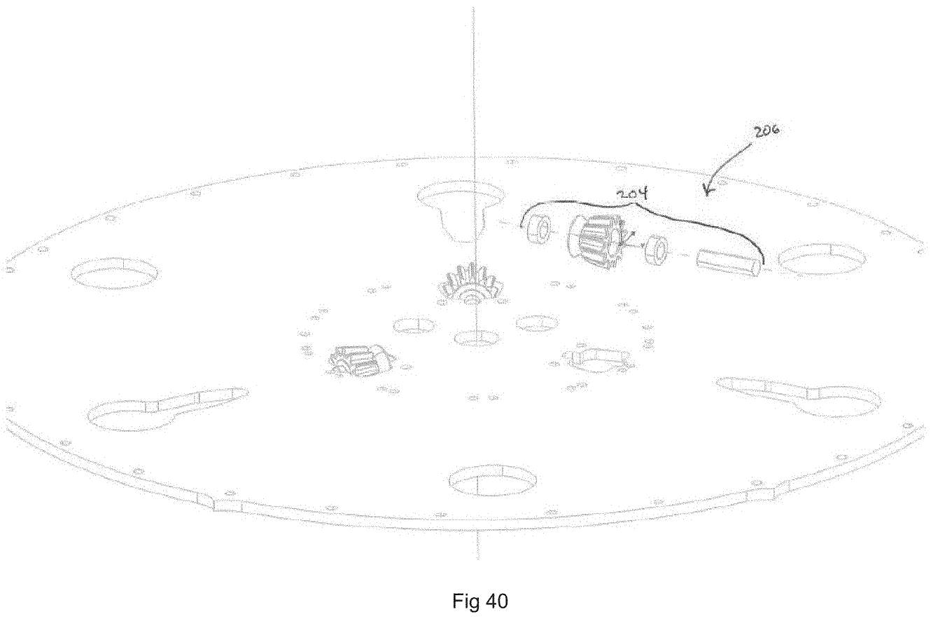

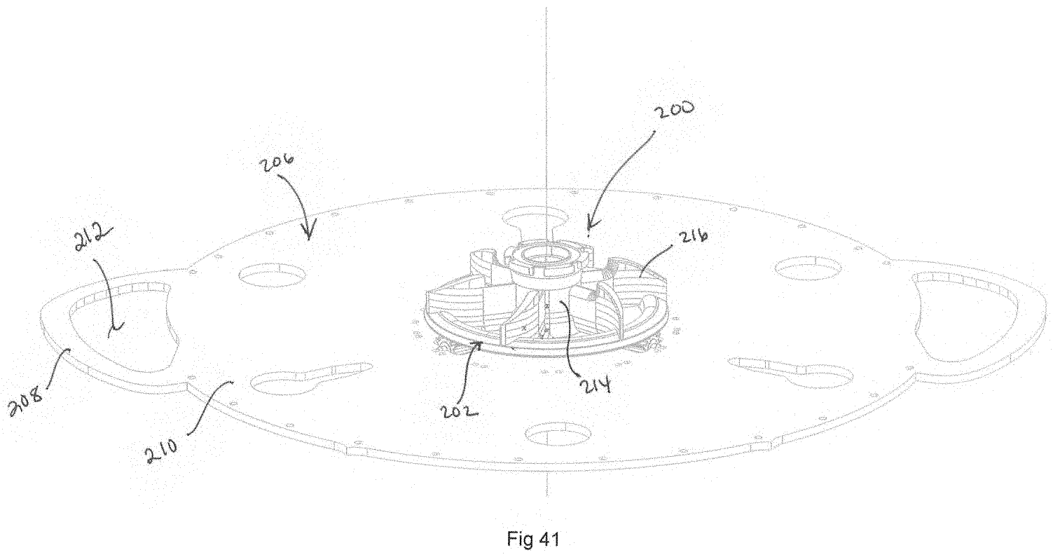

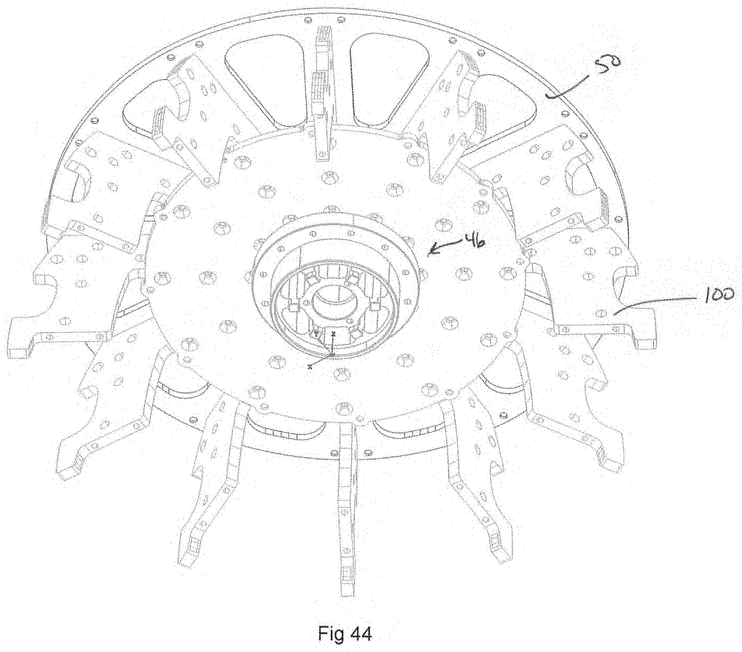

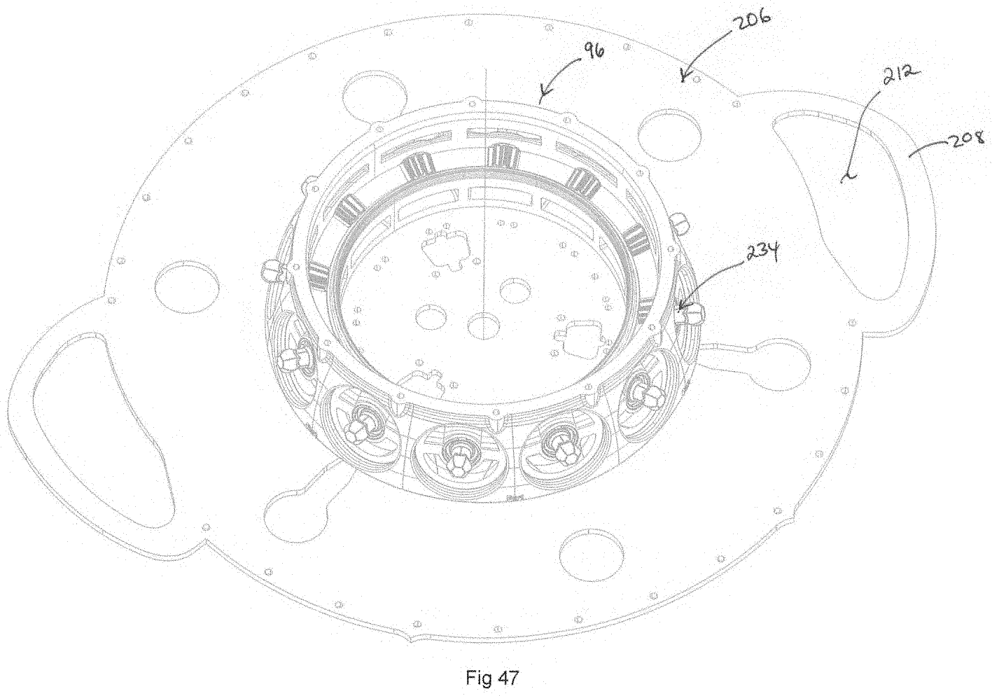

Referring now to specifically to FIGS. 38-53, there is depicted an alternative embodiment of a carousel impeller 200 having an integrated ring gear 202 that interfaces directly with the idler gears 204 to transfer rotational drive force from one side of the pump to the other side of the pump. The embodiment depicted in FIGS. 38-53 also includes an alternative embodiment of the middle plate 206, which includes a support rim 208 extending from a main portion 210 to define an opening 212 where the fluid transfer bodies 20 are connected to the middle plate 206.

The carousel impeller 200 includes a central hub 214 and a plurality of veins 216 extending radially outward from the central hub 214. The carousel impeller 200 additionally includes the ring gear 202, which may be connected to each vein 216 adjacent a distal end portion thereof. The ring gear 202 may be integrally connected to the veins 216 and may define an outer diameter that is similar to an outer diameter defined by the plurality of veins 216. The ring gear 202 includes gear teeth 218 that interface with idler gears 204 coupled to the middle plate 206. The interaction between the ring gear 202 and the idler gears 204 may result in the transfer rotation of the carousel impeller 200 on one side of the middle plate 206 to the carousel impeller 200 on the other side of the middle plate 206, such that the carousel impellers 200 rotate in opposite directions from each other.

The incorporation of the ring gear into the carousel impeller 200 allows for movement of the idler gears 204 to a more radially inward position relative to the position of the idler gears 204 included in the embodiment depicted in FIGS. 1-37. Furthermore, incorporation of the ring gear 202 into the carousel impeller 200 moves the ring gear 202 to a position that is radially inward of the vessels, and thus, any issues related to clearance between the vessels and the ring gears is mitigated. As such, incorporation of the ring gear 202 into the carousel impeller 200 may allow for a vessel that is of a larger volume, which may result in the generation of a greater force during operation of the pump assembly 10.

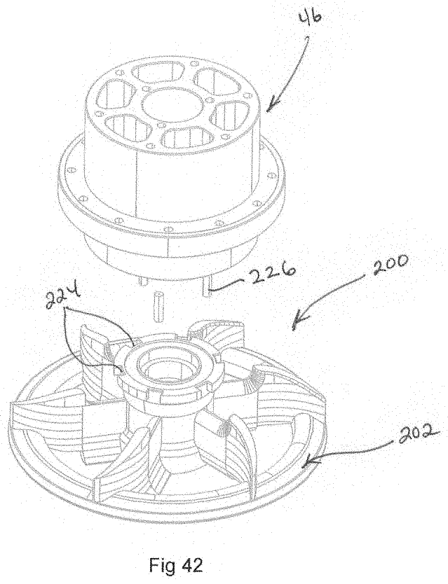

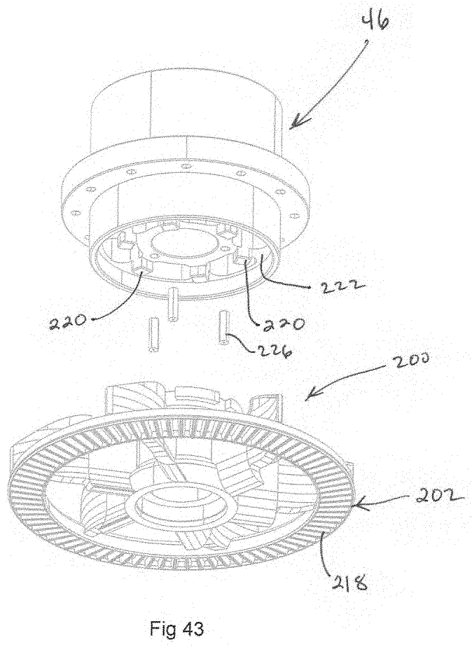

FIGS. 42-43 additionally depict an exemplary engagement between the hub 46 and the carousel impeller 200. In particular, a plurality of projections 220 may extend from an external surface 222 of the hub 46 and be received within corresponding recesses 224 or cavities formed in the carousel impeller 200. Thus, when the hub 46 rotates, the carousel impeller 200 additionally rotates due to the connection via the projections 220 and recesses 224. Set screws 226 may be used to adjust the relative position of the hub 46 relative to the carousel impeller 200.

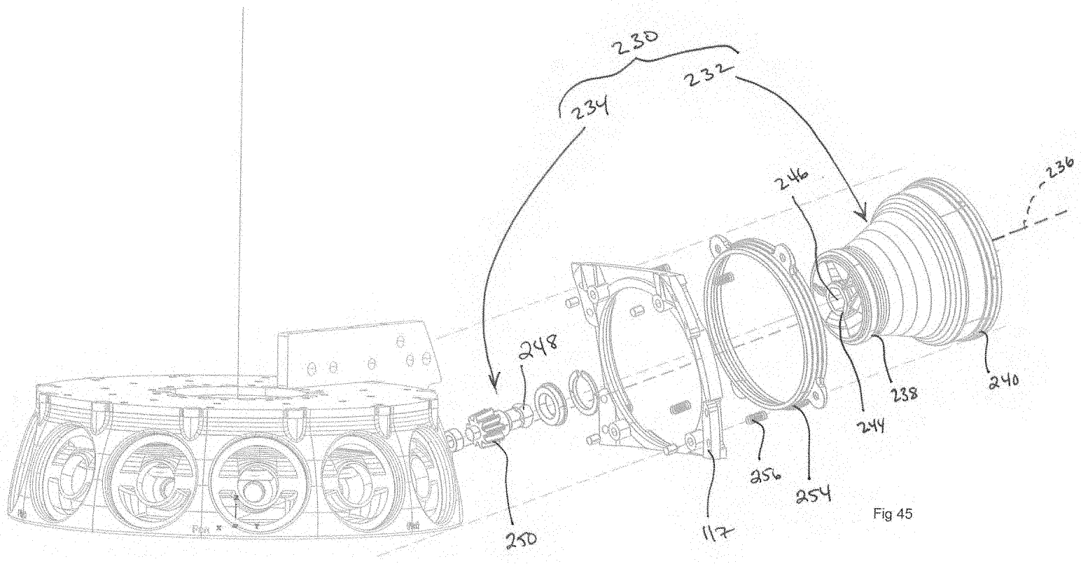

Referring now to FIGS. 45-48, there are depicted alternative embodiments of the vessels 230, a hex-drive for driving the vessels 230 about their respective vessel axis, a rack gear, and bearings for mitigating friction as a result of vessel motion.

Referring first to FIGS. 45-48, each vessel 230 may include a primary body 232 and gear body 234 detachably connectable to each other. The primary body 232 is disposed about a vessel axis 236 and includes a proximal end portion 238 and a distal end portion 240. The primary body 232 may additionally include a plurality of internal veins 242 that extend radially outward from a vein hub 244 toward the inner surface of the primary body 232. The vein hub 244 may include a multi-sided cavity 246 extending into the vein hub 244 from the proximal end portion 238 thereof, and more specifically from a proximal end surface. In the exemplary embodiment, the multi-sided cavity 246 is a hexagonal cavity (i.e., a six-sided cavity), although other cavity configurations may be implemented without departing from the spirit and scope of the present disclosure.

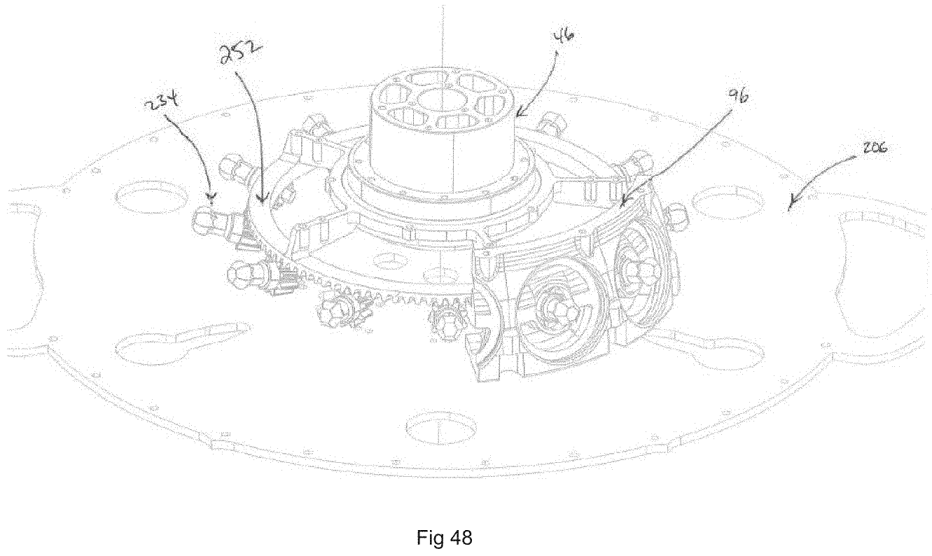

The hexagonal cavity 246 is configured to receive a portion of the gear body 234, and in particular, a hexagonally shaped body 248 formed thereon and connected to a geared shaft 250. The geared shaft 250 additionally includes a plurality of externally extending gear teeth adapted to mesh or interface with a rack gear 252 (see FIG. 48).

The interaction between the hexagonal body 248 and the hexagonal cavity 246 may synchronize rotational movement of the primary body 232 and the gear body 234 relative to the vessel axis 236, while at the same time allowing for movement of the primary body 232 relative to the gear body 234 along the vessel axis 236. Such movement may be minimal, but may allow for alignment of the gear body 234 with the rack gear 252, as well as movement of the primary body 232 proximate the shell 14. A spring may be located between the primary body 232 and the gear body 234 to urge the primary body 232 away from the gear body 234.

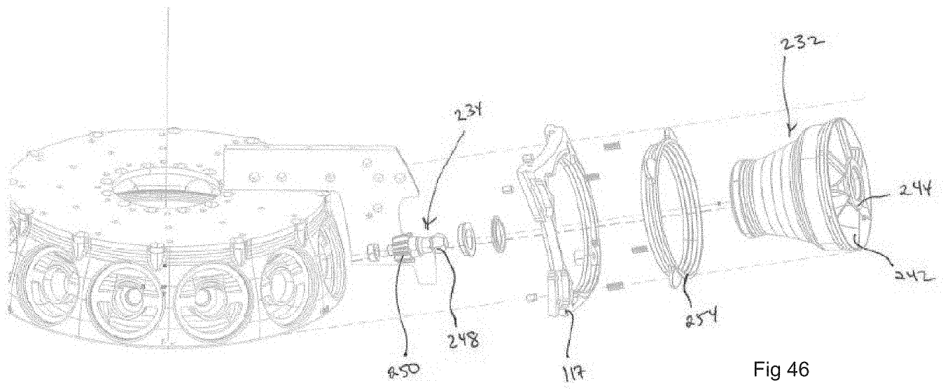

FIGS. 45 and 46 additionally depict a bearing 254 that resides between the vessel 230 and the vessel frame body 117. The bearing 254 is sized to extend around the distal end portion 240 of the primary body 232, while also being received within an opening formed in the vessel frame body 117 so as to minimize friction between the primary body 232 and the vessel frame body 117. One or more springs 256 may extend between the vessel frame body 117 and the bearing 117 to urge the bearing 117 away from the vessel frame body 117.

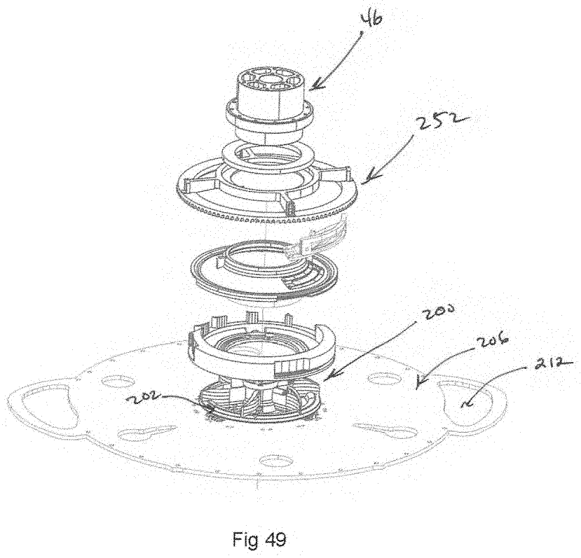

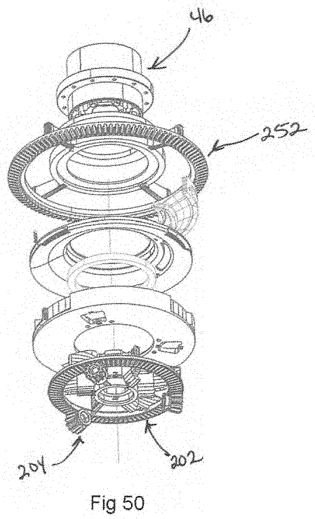

Referring now to FIGS. 49-50, there is depicted an alternative embodiment of the circular rack gear 252 which interfaces with the geared shaft 250 of the vessels 230 to cause rotation of the vessels 230 about their respective vessel axis 236.

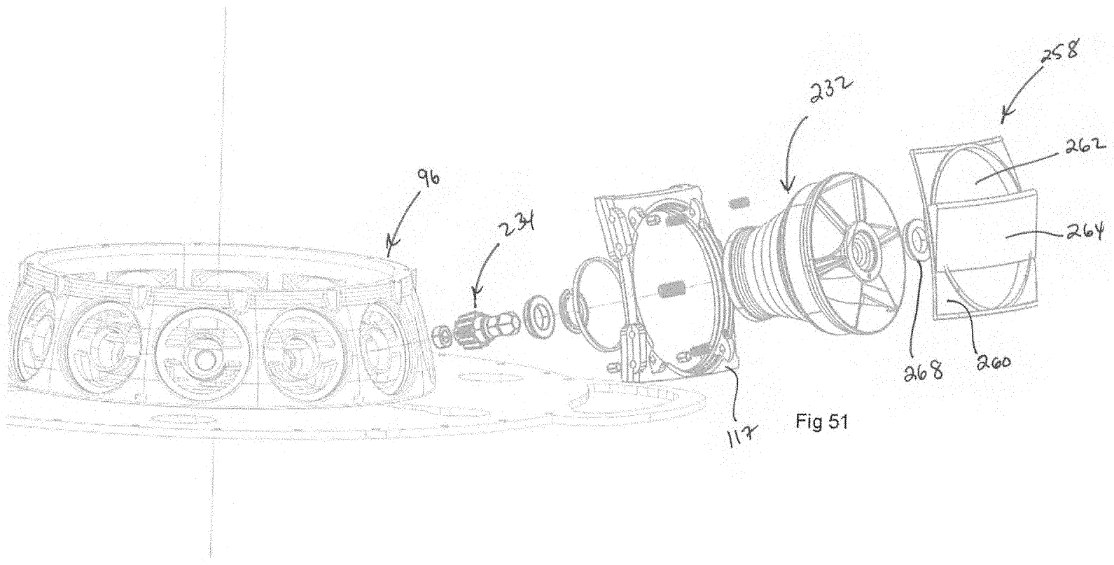

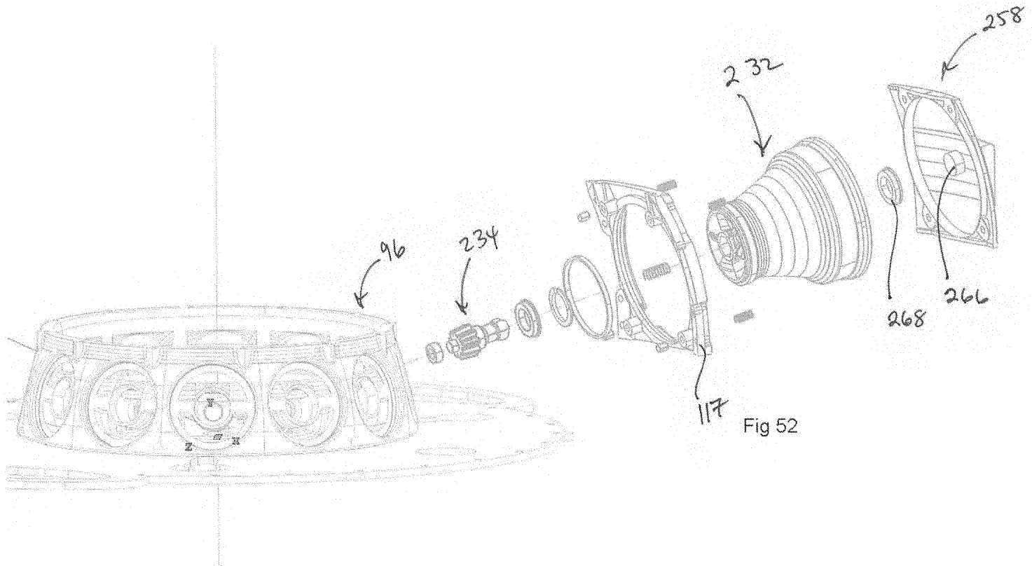

Referring now to FIGS. 51 and 52, there is depicted a crossbar frame 258 that is connected to the vessel frame body 117. The crossbar frame 258 may include a peripheral body 260 defining a central opening 262 that is similar in size to the diameter of the vessel 230 at the distal end portion 240 thereof. The opening 262 may be aligned with the vessel 230 to allow fluid to pass through both the central opening 262 and the vessel 230 as the pump assembly 10 is operating. The crossbar frame 258 may additionally include a cross bar body 264 extending across the central opening 262, with an inner surface of the crossbar body 264 having a boss 266 protruding therefrom. The boss 266 may be sized to interface with a bearing 268 that may minimize friction applied to the vessel 230 and facilitate rotation of the vessel 230 about the vessel axis 236. It is also contemplated that the crossbar body 264 may interface with an internal surface of the shell 14 to minimize friction between the that may be caused by the shell 14. In one embodiment, the crossbar body 264 includes an outer surface that mimics the curvature/contour of the inner surface of the shell 14.

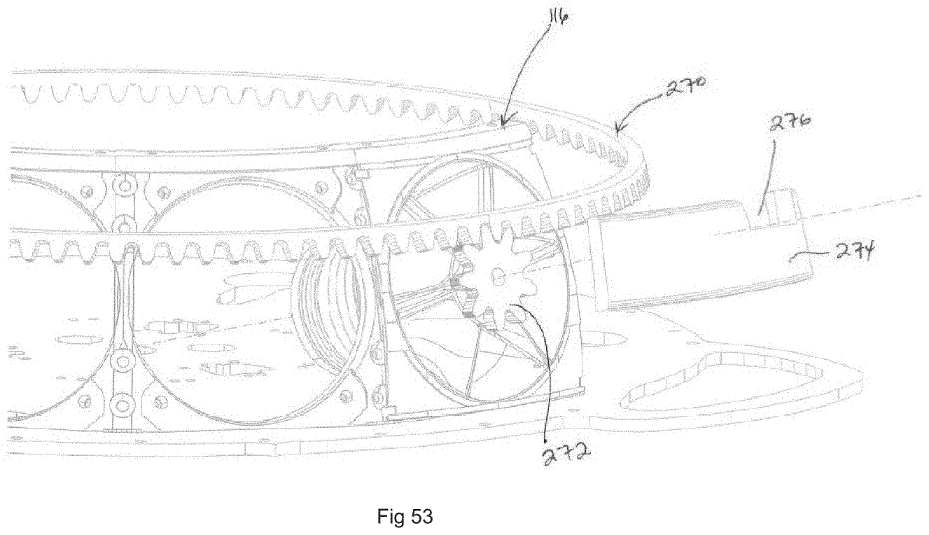

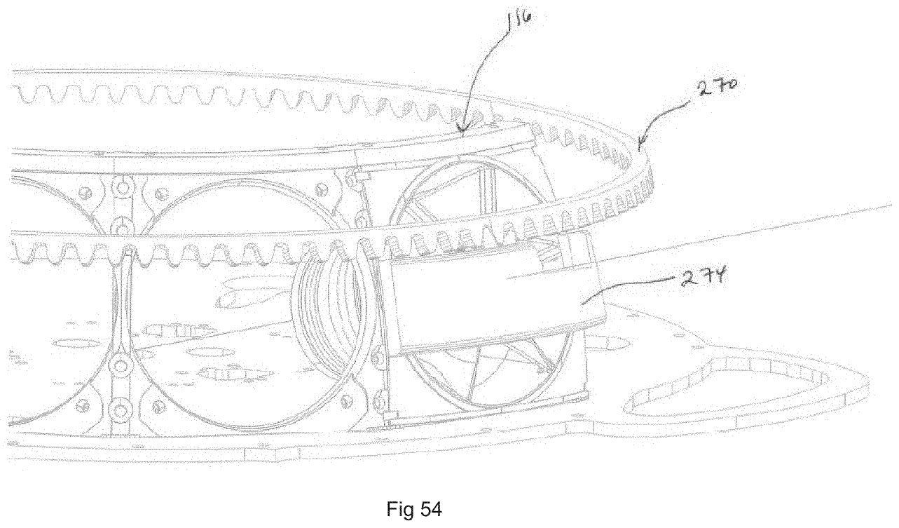

Referring now to FIGS. 53 and 54, there is depicted an alternative rotational drive mechanism for the vessels 230. In particular, a ring gear 270 may be located radially outward relative to the vessel frame 116 and may be configured to interface with pinion gears 272 connected to a distal end portion of the vessels 230. As the pinion gear 272 rotates on the ring gear 270, the vessel 230 rotates with the pinion gear 272 about its vessel axis 236. In this regard, the location of any gearing that may be used to facilitate rotation of the vessel 230 about its vessel axis 236 may be located adjacent the proximal end portion 238 (e.g., radially inward), or the distal end portion 240 (e.g., radially outward).

FIGS. 53 and 54 additionally depict an alternative embodiment of the crossbar body 274, which extends across the distal end portion 240 of the vessel 230. The crossbar body 274 may include a timing port 276 formed therein to define an effective size of a vessel cavity that may be exposed to the fluid transfer bodies 20.

Although the foregoing embodiments describe the pump assembly 10 as including a pair of carousel impellers 54, 200, it is contemplated that other embodiments of the pump assembly 10 may be formed without carousel impellers 54, 200. In this regard, the fluid that would otherwise be directed by the carousel impellers 54, 200 may be urged solely by the centrifugal pump 24. Furthermore, it is also contemplated that the configuration of the vessels may vary without departing from the spirit and scope of the present disclosure. In particular, the vessels may be tubular, with a generally uniform inner and outer diameter along their length.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A pump assembly comprising:
a shell having an inner surface defining an internal chamber; and
a pumping frame moveable within the internal chamber;
the shell and the pumping frame collectively defining a fluid circuit having a pair of arcuate segments, the pumping frame being configured to induce fluid along the fluid circuit in response to movement of the pumping frame relative to the shell, fluid movement along the pair of arcuate segments generating a centrifugal force in a prescribed direction capable of independently moving the pump assembly.

2. The pump assembly as recited in claim 1, wherein the pumping frame is rotatable relative to the shell about a central axis.

3. The pump assembly as recited in claim 2, wherein the pair of arcuate segments are both disposed about the central axis.

4. The pump assembly as recited in claim 1, wherein the shell includes a main body and a pair of fluid transfer bodies coupled to the main body in generally opposed relation to each other, each fluid transfer body being configured to transfer fluid from one arcuate segment to the other arcuate segment.

5. The pump assembly as recited in claim 1, wherein the shell and the pumping frame are configured to generate the centrifugal force in the prescribed direction independent of discharging any fluid from the shell.

6. The pump assembly as recited in claim 1, wherein the pumping frame includes a first carousel rotatable within the shell about a central axis in a first rotational direction and a second carousel rotatable within the shell about the central axis in a second rotational direction opposite the first rotational direction.

7. The pump assembly as recited in claim 6, further comprising a plurality of vessels, each vessel being rotatably coupled to a respective one of the first carousel and the second carousel.

8. The pump assembly as recited in claim 7, wherein each vessel includes a proximal end portion adjacent the central axis and a distal end portion extending away from the central axis, each vessel being configured to rotate relative to the pumping frame about a respective vessel axis extending from the proximal end portion toward the distal end portion.

9. The pump assembly as recited in claim 8, wherein each vessel includes an outer body and a plurality of veins extending within the outer body.

10. The pump assembly as recited in claim 9, wherein the first carousel overlaps with the fluid circuit to define a first wet region of the first carousel, the pump assembly further comprising a first impeller configured to urge fluid from a fluid source within the internal chamber toward the first wet region.

11. The pump assembly as recited in claim 10, further comprising a diffuser extending around the first impeller and having a plurality of passageways extending radially therethrough between the first impeller and the first wet region.

12. A force generating device configured to generate a force in as a result of fluid movement within the force generating device, the force generating device comprising:
an outer shell having an internal chamber; and
a pumping assembly moveable within the outer shell and at least partially defining a pair of force generating fluid movement segments and a pair of transfer flow segments, the pair of force generating fluid movement segments configured to collectively generate a sufficient force to independently move the force generating device in response to fluid flow through the force generating fluid movement segments, the pair of transfer flow segments configured to transfer fluid between the pair of force generating fluid movement segments and generate a pair of forces that counteract each other as fluid flows through the pair of transfer flow segments.

13. The force generating device as recited in claim 12, wherein the outer shell and the pumping assembly are configured to generate the sufficient force independent of discharging fluid from the force generating device.

14. The force generating device as recited in claim 12, wherein the pair of force generating fluid movement segments are of an arcuate configuration.

15. The force generating device as recited in claim 14, further comprising a middle plate located within the shell and dividing the interior chamber into a pair of sub-chambers, the pair of force generating fluid movement segments being located in respective ones of the pair of sub-chambers.

16. The force generating device as recited in claim 15, wherein each of the pair of transfer flow segment is configured to transmit fluid from a first one of the pair of sub-chambers to a second one of the pair of sub-chambers.

17. The force generating device as recited in claim 15, wherein the pumping assembly includes a first sub-assembly and a second sub-assembly located in respective ones of the pair of sub-chambers, at least a portion of the first sub-assembly and at least a portion of the second sub-assembly being rotatable about a central axis about which at least a portion of the shell is disposed.

18. The force generating device as recited in claim 17, wherein the at least a portion of the first sub-assembly being rotatable about the central axis is rotatable in a first rotational direction and the at least a portion of the second sub-assembly being rotatable about the central axis is rotatable in a second rotational direction opposite the first rotational direction.

19. A pump assembly comprising:
an outer shell including:
a main body defining an internal chamber; and
a pair of fluid transfer bodies in fluid communication with the internal chamber and extending from the main body in generally opposed relation to each other, each fluid transfer body having an inlet port configured to receive fluid and an outer port configured to discharge fluid;
a first set of vessels configured to move within the internal chamber and receive fluid from the outlet port of a first one of the pair of fluid transfer bodies and deliver fluid to the inlet port of a second one of the pair of fluid transfer bodies; and
a second set of vessels configured to move within the internal chamber and receive fluid from the outlet port of the second one of the pair of fluid transfer bodies and deliver fluid to the inlet port of the first one of the pair of fluid transfer bodies;
fluid movement by the first and second sets of vessels between the respective inlet and outlet ports generating a force sufficient to move the pump assembly.

20. The pump assembly as recited in claim 19, wherein the first and second sets of vessels move in an arcuate path between the respective inlet and outlet ports.
